(19) United States
(12) Patent Application Publication
(10) Pub. No.: US 2026/0232130 A1
(43) Pub. Date: Aug. 13, 2026

(54) TUMBLER

(71) Applicant: SIHBO CO., LTD., New Taipei City (TW)

(72) Inventor: Chi-Cheng LAN, New Taipei City (TW)

(73) Assignee: SIHBO CO., LTD., New Taipei City (TW)

(21) Appl. No.: 19/159,986

(22) PCT Filed: Mar. 15, 2024
(86) PCT No.: PCT/CN2024/081933

§ 371 Date: Aug. 26, 2025

(30) Foreign Application Priority Data
Mar. 17, 2023 (CN) 202310260774.7

(51) Int. Cl. A47J 31/22

(52) U.S. Cl. CPC A47J 31/22

(57) ABSTRACT

A tumbler including a tumbler body, a lifting component, a manipulated component and a first magnetic assembly. The tumbler body includes a bottle portion and a lower blocking portion. The bottle portion has an accommodating space. The lower blocking portion protrudes from the bottle portion, and is located in the accommodating space. The lifting component is located in the accommodating space. The manipulated component is located outside the accommodating space, and is movably disposed on the bottle portion, which can be moved along an axial direction thereof. The first magnetic assembly includes a first magnetic component and a second magnetic component. The first magnetic component is disposed on the lifting component. The second magnetic component is disposed on the manipulated component, and attracts the first magnetic component. The manipulated component forces the lifting component to be moved via a magnetic force.

### CROSS-REFERENCE TO RELATED APPLICATIONS

This non-provisional application claims priority under 35 U.S.C. § 119(a) on Patent Application No(s). 202310260774.7 filed in China, on Mar. 17, 2023, the entire contents of which are hereby incorporated by reference.

### TECHNICAL FIELD

The present disclosure relates to a tumbler, more particularly to a tumbler capable of regulating the concentration of a beverage.

### BACKGROUND

Recently, people pursue environmental protection and reduce the use of disposable plastic containers. Therefore, carrying a tumbler to hold or brew beverages has become a trend in modern society.

When a beverage is to be brewed, a brewing substance is placed into the tumbler, and a hot water is poured into the tumbler, thereby obtaining a brewed beverage. However, since the conventional tumbler has a structural limitation disturbing the concentration of the brewed beverage from being regulated by promptly removing the brewing substance, the brewing substance may be steeped in the water for a long time, thereby causing undesired concentration of the beverage that does not meet the his/her preference. Therefore, how to allow the user to conveniently regulate the concentration of the brewed beverage in the tumbler according to the personal preference is one of the problems required to be addressed.

### SUMMARY

The present disclosure provides a tumbler so as to allow a user to conveniently regulate a concentration of a brewed beverage in the tumbler according to a personal preference.

One embodiment of the present disclosure provides a tumbler including a tumbler body, a lifting component, a manipulated component and a first magnetic assembly. The tumbler body includes a bottle portion and a lower blocking portion. The bottle portion has an accommodating space. The lower blocking portion protrudes from the bottle portion. The lower blocking portion is located in the accommodating space. The lifting component is located in the accommodating space. The lifting component includes a separating portion and at least one hollow portion. The at least one hollow portion is connected to the separating portion. The manipulated component is located outside the accommodating space. The manipulated component is movably disposed on the bottle portion. The manipulated component is configured to be moved along an axial direction thereof. The first magnetic assembly includes at least one first magnetic component and at least one second magnetic component. The at least one first magnetic component is disposed on the lifting component. The at least one second magnetic component is disposed on the manipulated component. The at least one second magnetic component attracts the at least one first magnetic component. The manipulated component forces the lifting component to be moved between a brewing position and a drinking position relative to the bottle portion via a magnetic force. When the lifting component is located at the brewing position, the separating portion is detached from the lower blocking portion, and two spaces respectively located on opposite two sides of the lifting component are in fluid communication with each other via the at least one hollow portion. When the lifting component is located at the drinking position, the separating portion presses against the lower blocking portion to from a separating structure together with the lower blocking portion, and the fluid communication between two spaces respectively located on opposite two sides of the lifting component blocked by the separating structure blocking the at least one hollow portion.

According to the tumbler as described in the above embodiments, the manipulated component can force the lifting component to be moved between the brewing position and the drinking position via the magnetic force. In detail, when the lifting component is located at the brewing position, the separating portion is detached from the lower blocking portion, and the first accommodating space and the second accommodating space respectively located on opposite two sides of the lifting component are in fluid communication with each other via the hollow portion. When the lifting component is located at the drinking position, the separating portion presses against the lower blocking portion to from a separating structure together with the lower blocking portion, and the fluid communication between the first accommodating space and the second accommodating space respectively located on opposite two sides of the lifting component blocked by the separating structure blocking the hollow portion. Therefore, the brewed beverage is separated from the brewing substance, thereby terminating the brewing process for the brewing substance. Thus, when the concentration of the brewed beverage in the tumbler does not meet his/her preference, the lifting component can be moved between the brewing position and the drinking position to regulate the concentration of the brewed beverage. Accordingly, the user can enjoy the brewed beverage with an optimal flavor.

The aforementioned description of the present disclosure and the following detailed embodiments are provided to illustrate and explain the principles of the disclosure, and to offer further clarification of the scope of the claims of the present disclosure.

### BRIEF DESCRIPTION OF THE DRAWINGS

FIG. 1 is a perspective view of a tumbler in accordance with a first embodiment of the present disclosure;

FIG. 2 is an exploded view of the tumbler in FIG. 1;

FIG. 3 is a partially exploded view of the tumbler in FIG. 1;

FIG. 4 is a cross-sectional view of the tumbler in FIG. 1;

FIG. 5 is a cross-sectional view of a lifting component in FIG. 1 located at a brewing position;

FIG. 6 is a cross-sectional view of the lifting component in FIG. 1 located at a drinking position;

FIG. 7 is a cross-sectional view of a tumbler in accordance with a second embodiment of the present disclosure;

FIG. 8 is a perspective view of a tumbler in accordance with a third embodiment of the present disclosure;

FIG. 9 is a partially exploded view of the tumbler in FIG. 8;

FIG. 10 is partially exploded view of the tumbler in FIG. 8 from another viewing angle;

FIG. 11 is a top view showing that an upper cover in FIG. 8 is opened;

FIG. 12 is a top view showing that the upper cover in FIG. 8 is closed;

FIG. 13 is a bottom view of the upper cover in FIG. 8;

FIG. 14 is a cross-sectional view of the upper cover in FIG. 8;

FIG. 15 is a cross-sectional view showing that a push-push telescopic structure in FIG. 8 is rotated;

FIG. 16 is a perspective view of a tumbler in accordance with a fourth embodiment of the present disclosure;

FIG. 17 is an exploded view of the tumbler in FIG. 16;

FIG. 18 is a partially exploded view of a part of the tumbler in FIG. 16;

FIG. 19 is a cross-sectional view of the tumbler in FIG. 16;

FIG. 20 is a perspective view of a tumbler in accordance with a fifth embodiment of the present disclosure;

FIG. 21 is an exploded view of the tumbler in FIG. 20;

FIG. 22 is a partially exploded view of a part of the tumbler in FIG. 20;

FIG. 23 is a cross-sectional view of the tumbler in FIG. 20;

FIG. 24 is a cross-sectional view of the tumbler in FIG. 20 from another viewing angle;

FIG. 25 is a cross-sectional view of a lifting component in FIG. 20 located at a brewing position;

FIG. 26 is a cross-sectional view of the lifting component in FIG. 20 located at a drinking position;

FIG. 27 is an exploded view of a tumbler in accordance with a sixth embodiment of the present disclosure;

FIG. 28 is a partially exploded view of a part of the tumbler in FIG. 27;

FIG. 29 is a cross-sectional view of the tumbler in FIG. 27;

FIG. 30 is a cross-sectional view of the tumbler in FIG. 27 from another viewing angle;

FIG. 31 is an exploded view of a tumbler in accordance with a seventh embodiment of the present disclosure;

FIG. 32 is a cross-sectional view of the tumbler in FIG. 31;

FIG. 33 is a cross-sectional view of a tumbler in accordance with an eighth embodiment of the present disclosure;

FIG. 34 is a perspective view of a tumbler in accordance with a ninth embodiment of the present disclosure;

FIG. 35 is an exploded view of the tumbler in FIG. 34;

FIG. 36 is a partially exploded view of a part of the tumbler in FIG. 34;

FIG. 37 is a cross-sectional view of the tumbler in FIG. 34;

FIG. 38 is a cross-sectional view of the tumbler in FIG. 34 from another viewing angle;

FIG. 39 is a cross-sectional view of a tumbler in accordance with a tenth embodiment of the present disclosure;

FIG. 40 is a cross-sectional view of the tumbler in FIG. 39 from another viewing angle;

FIG. 41 is a cross-sectional view of a tumbler in accordance with an eleventh embodiment of the present disclosure.

### DETAILED DESCRIPTION

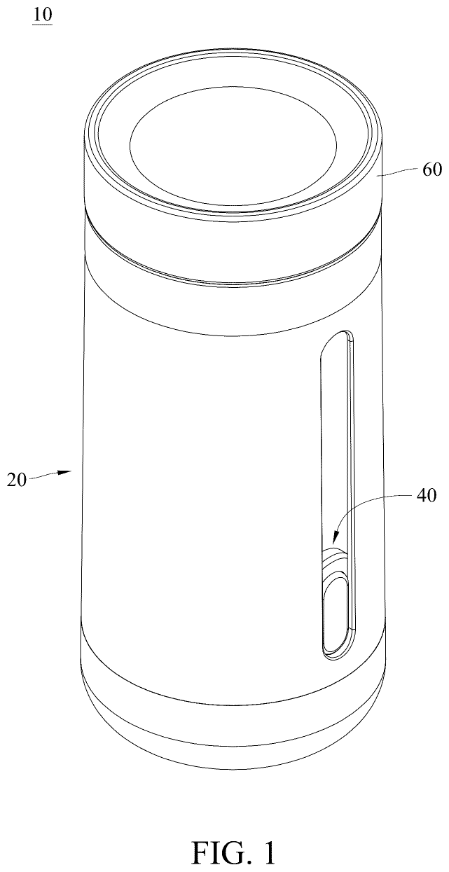

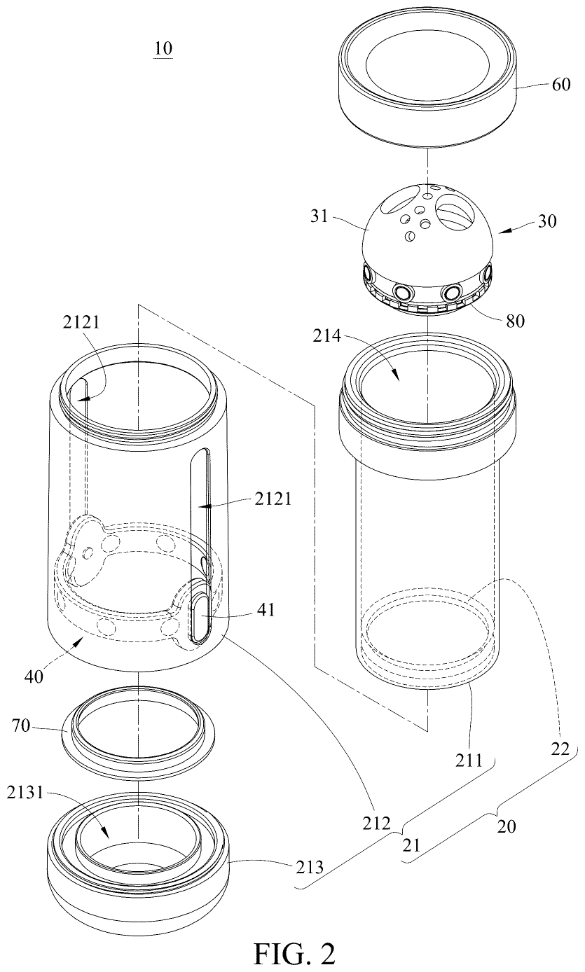

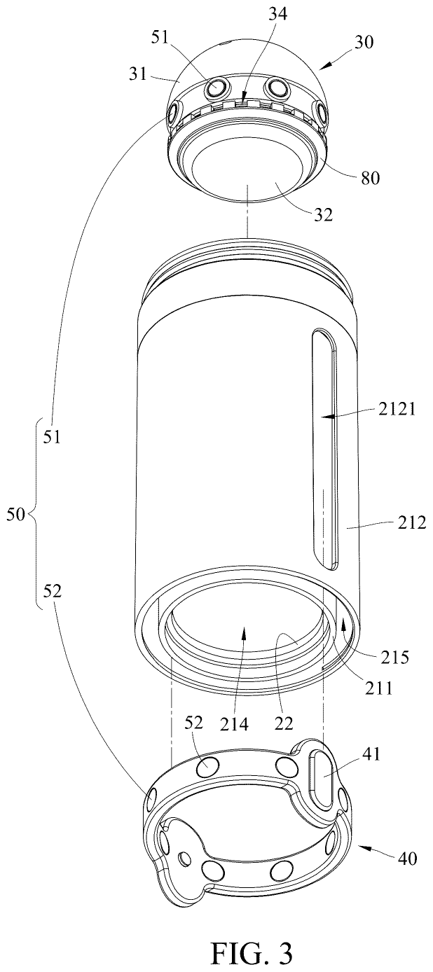

Please refer to FIG. 1 to FIG. 3, where FIG. 1 is a perspective view of a tumbler in accordance with a first embodiment of the present disclosure, FIG. 2 is an exploded view of the tumbler in FIG. 1, and FIG. 3 is a partially exploded view of the tumbler in FIG. 1.

In this embodiment, the tumbler 10 is, but not limited to, a thermos having thermal insulation properties. The tumbler 10 includes a tumbler body 20, a lifting component 30, a manipulated component 40, a plurality of first magnetic assemblies 50 and an upper cover 60. The tumbler body 20 includes a bottle portion 21 and a lower blocking portion 22. The bottle portion 21 includes an inner bottle part 211, an outer bottle base 212 and a lower cover 213. The inner bottle part 211 forms a first accommodating space 214. The outer bottle base 212 is sleeved over the inner bottle part 211 and assembled thereon. A sliding recess 215 is formed between the outer bottle base 212 and the inner bottle part 211. The sliding recess 215 is spaced apart from the first accommodating space 214. Two opposite sides of the outer bottle base 212 has an opening 2121. The two openings 2121 are connected to the sliding recess 215. The lower cover 213 is, for example, screwed to a bottom side of the bottle portion 21, and covers the sliding recess 215 and the first accommodating space 214. The lower cover 213 forms a second accommodating space 2131. The second accommodating space 2131 is configured to accommodate a brewing substance 200, such as tea leaves. After the brewing substance 200 is placed into the second accommodating space 2131, a hot water can be poured into the tumbler body 20 to brew a brewed beverage 300, such as a tea, in the first accommodating space 214. The lower blocking portion 22 protrudes from the bottle portion 21, and is located in the first accommodating space 214.

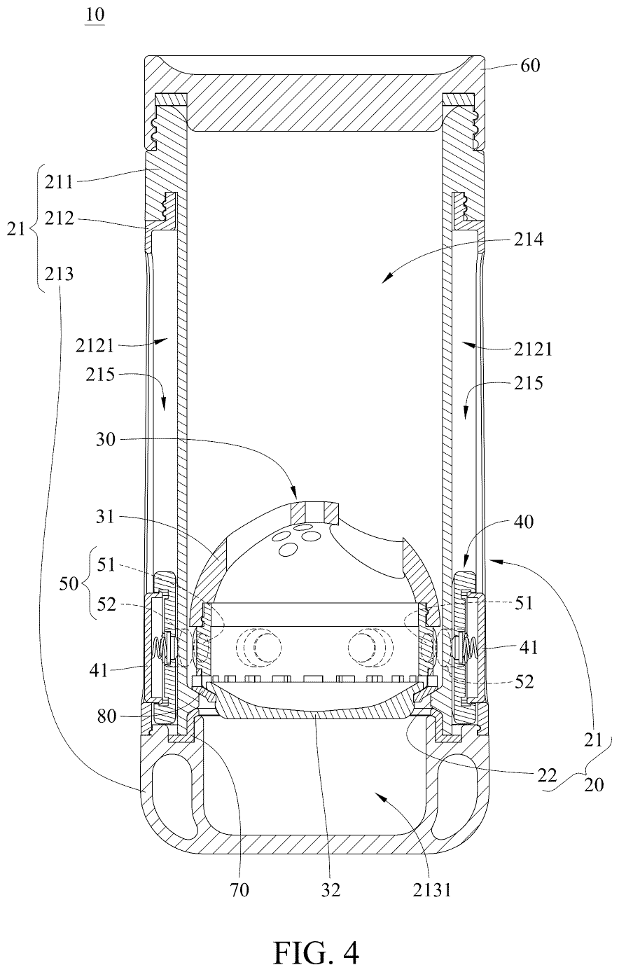

Please refer to FIG. 1 to FIG. 4, where FIG. 4 is a cross-sectional view of the tumbler in FIG. 1. The lifting component 30 is located in the first accommodating space 214, and includes a hollow portion 31 and a separating portion 32. The hollow portion 31 is connected to the separating portion 32. The first accommodating space 214 is configured to be in fluid communication with the second accommodating space 2131 via the hollow portion 31. The separating portion 32 may press against the lower blocking portion 22 of the tumbler body 20, thereby blocking the fluid communication between the first accommodating space 214 and the second accommodating space 2131.

The manipulated component 40 is located outside the first accommodating space 214, and two opposite sides of the manipulated component 40 includes two manipulated portions 41. The manipulated component 40 is slidably disposed on the bottle portion 21 along an axial direction thereof, and the two manipulated portions 41 are located at the two openings 2121 of the outer bottle base 212, respectively. Each of the first magnetic assemblies 50 includes a plurality of first magnetic components 51 and a plurality of second magnetic components 52. The first magnetic components 51 and the second magnetic components 52 are, for example, magnets. The first magnetic components 51 are disposed on the lifting component 30. The second magnetic components 52 are disposed on the manipulated component 40, and the second magnetic components 52 attract the first magnetic components 51, respectively, such that the manipulated component 40 may raise or lower the lifting component 30 relative to the bottle portion 21 via a magnetic force. The upper cover 60 is, for example, screwed to a top side of the tumbler body 20, and covers the first accommodating space 214.

In this embodiment, the lifting component 30 may be moved between a brewing position and a drinking position relative to the bottle portion 21 via the magnetic force. When the manipulated component 40 raises the lifting component 30 to the brewing position, the separating portion 32 is detached from the lower blocking portion 22, and the first accommodating space 214 and the second accommodating space 2131 respectively located on opposite two sides of the lifting component 30 are in fluid communication with each other via the hollow portion 31. Therefore, the hot water can continuously brew the brewing substance 200. When the manipulated component 40 lowers the lifting component 30 to the drinking position, the separating portion 32 presses against the lower blocking portion 22 to from a separating structure together with the lower blocking portion 22, and the fluid communication between the first accommodating space 214 and the second accommodating space 2131 respectively located on opposite two sides of the lifting component 30 are blocked by via the separating structure blocking the hollow portion 31. Therefore, the brewed beverage 300 is separated from the brewing substance 200, thereby terminating the brewing process for the brewing substance 200.

In this embodiment, the tumbler 10 may further include a first sealing pad 70. The first sealing pad 70 is, for example, a rubber ring. The first sealing pad 70 is clamped between the lower cover 213 and the bottle portion 21. Accordingly, a sealing performance between the lower cover 213 and the bottle portion 21 can be improved by the first sealing pad 70, thereby preventing the brewed beverage 300 from leaking out from a gap therebetween.

In this embodiment, the tumbler 10 may include a second sealing pad 80. The second sealing pad 80 is, for example, a rubber ring. The second sealing pad 80 is disposed on the separating portion 32 of the lifting component 30. Accordingly, a sealing performance between the separating portion 32 and the lower blocking portion 22 can be improved by the second sealing pad 80, thereby preventing the brewed beverage 300 from flowing from the first accommodating space 214 to the second accommodating space 2131.

In this embodiment, there are multiple first magnetic components 51 and multiple second magnetic components 52, and the second magnetic components 52 attract the first magnetic components 51, respectively, such that the lifting component 30 can be raised or lowered relative to the bottle portion 21 via the magnetic force, but the present disclosure is not limited thereto. In other embodiment, there may be one first magnetic component and one second magnetic component, and the second magnetic component attracts the first magnetic component, such that the lifting component can be raised or lowered relative to the bottle portion via the magnetic force.

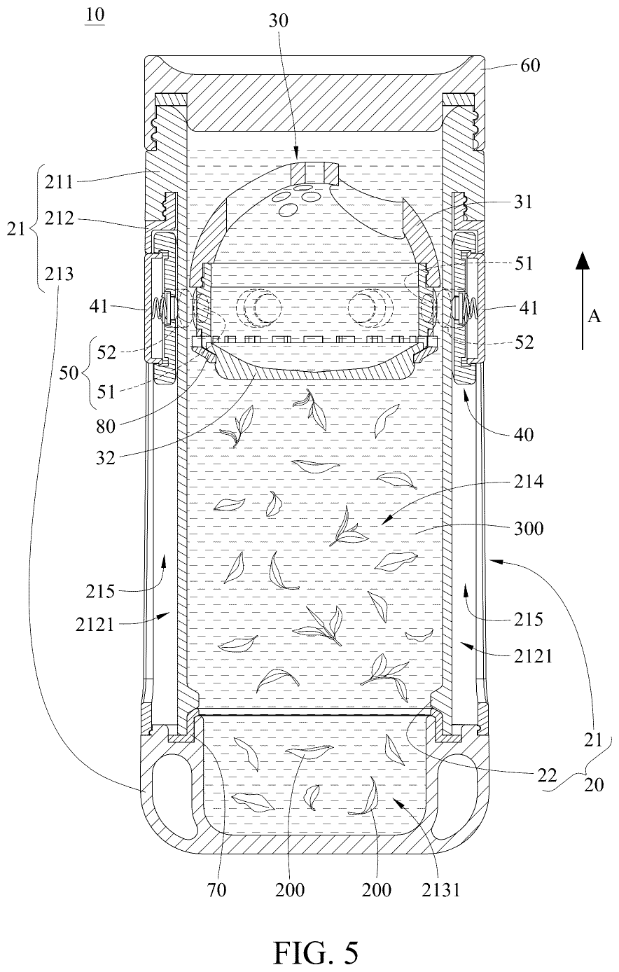

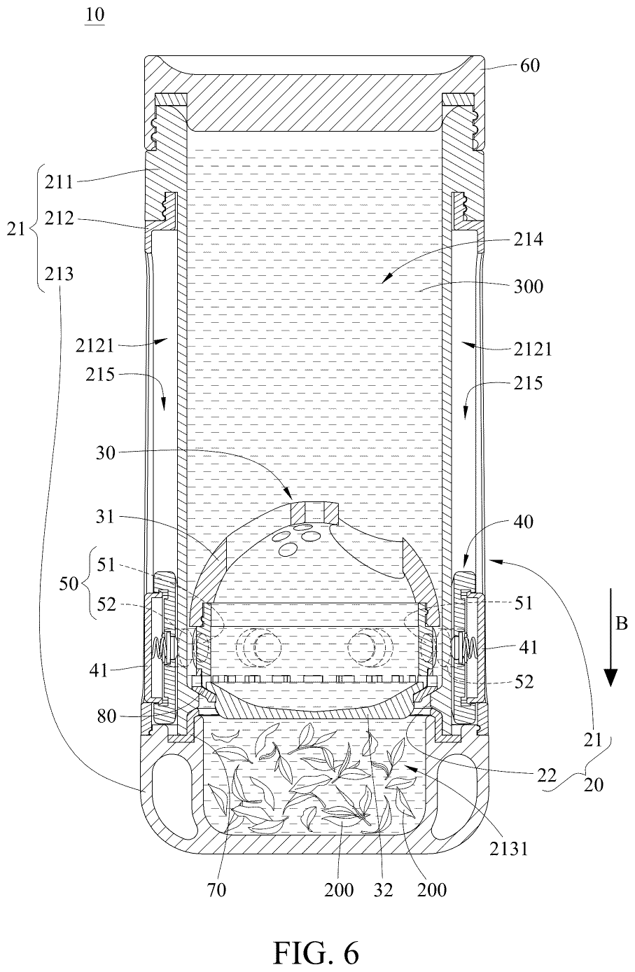

Please refer to FIG. 5 and FIG. 6, where FIG. 5 is a cross-sectional view of the lifting component in FIG. 1 located at the brewing position, and FIG. 6 is a cross-sectional view of the lifting component in FIG. 1 located at the drinking position.

As shown in FIG. 5, when the user is required to brew the tea, the user may place the brewing substance 200 into the second accommodating space 2131 of the lower cover 213 and screw the lower cover 213 to the bottle portion 21, such that the first accommodating space 214 of the bottle portion 21 is in fluid communication with the second accommodating space 2131. Accordingly, the brewed beverage 300 may be brewed via the brewing substance 200 steeped in the hot water. Then, the user presses the manipulated portion 41 of the manipulated component 40, such that the manipulated component 40 forces the lifting component 30 to be raised to the brewing position along a direction A via the magnetic force generated between the first magnetic components 51 and the second magnetic components 52, and the hot water can be poured into the tumbler body 20 to steep the brewing substance 200 in the hot water and brew the brewed beverage 300. At this time, the brewed beverage 300 can flow between the first accommodating space 214 and the second accommodating space 2131 via the hollow portion 31 of the lifting component 30.

As shown in FIG. 6, when the user feels that a concentration of the brewed beverage 300 meets his/her preference, the user may press the manipulated portions 41 of the manipulated component 40, such that the manipulated component 40 forces the lifting component 30 to be lowered from the brewing position to the drink position along a direction B via the magnetic force generated between the first magnetic components 51 and the second magnetic components 52. At this time, the separating portion 32 of the lifting component 30 presses against the lower blocking portion 22 of the tumbler body 20, and blocks the fluid communication between the first accommodating space 214 and the second accommodating space 2131, thereby preventing the brewed beverage 300 brewed with the brewing substance 200 located in the second accommodating space 2131 from flowing to the first accommodating space 214. That is, the concentration of the brewed beverage 300 located in the first accommodating space 214 is prevented from being increased over time due to prolonged brewing.

When the lifting component 30 is located at the brewing position, the first accommodating space 214 is in fluid communication with the second accommodating space 2131. Therefore, the brewing substance 200 located in the second accommodating space 2131 can be steeped in the brewed beverage 300 located in the first accommodating space 214. When the lifting component 30 is located at the drinking position, the first accommodating space 214 is not in fluid communication with the second accommodating space 2131. Therefore, the brewing substance 200 located in the second accommodating space 2131 is not steeped in the brewed beverage 300 located in the first accommodating space 214. Accordingly, the user can regulate the concentration of the brewed beverage 300 according to his/her preference by moving via the lifting component 30 between the brewing position and the drinking position.

In the conventional tumbler, the manipulated component forcing the lifting component to be moved is located close to a mouth of the bottle portion. Therefore, during the brewing process, the user cannot close the upper cover onto the tumbler body until the brewing process is completed. On the contrary, in this embodiment, since the manipulated component 40 forcing the lifting component 30 to be moved is located on two opposite sides of the tumbler body 20, the manipulated component 40 does not obstruct the upper cover 60 from being closed onto the tumbler body 20. As a result, when the user is in a hurry to go out, the user can firstly close the upper cover 60 onto the tumbler body 20, and then moves the lifting component 30 to the brewing position via the manipulated component 40 while on the go. Accordingly, the user does not require to spend additional time waiting for the brewed beverage 300 to finish the brewing, thereby saving the brewing time and improving the convenience of beverage preparation.

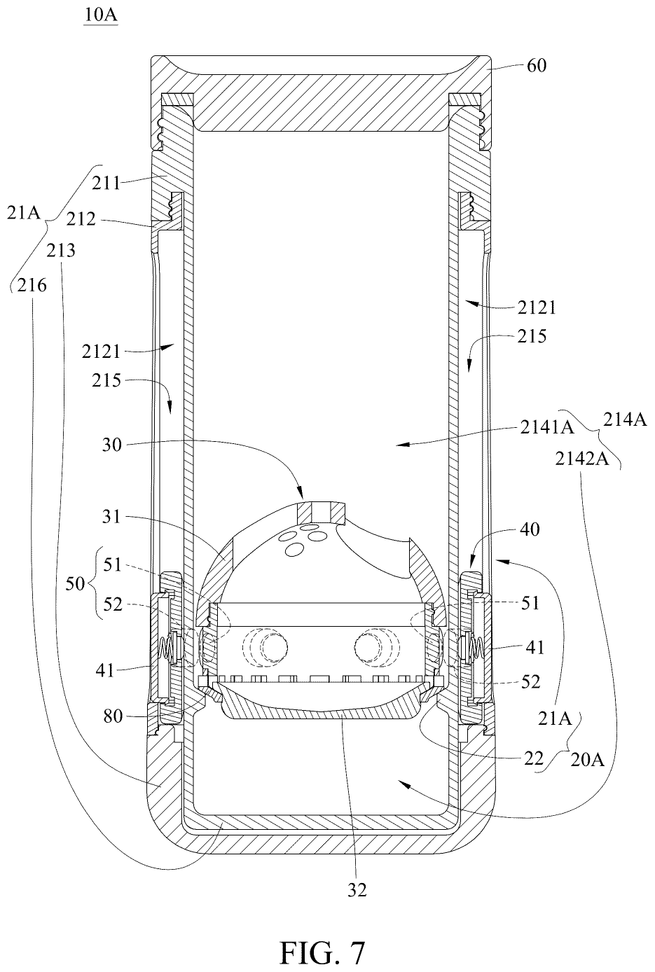

Please refer to FIG. 7, which is a cross-sectional view of a tumbler in accordance with a second embodiment of the present disclosure. The tumbler 10A of the present embodiment is similar to the tumbler 10 of the first embodiment. Accordingly, the following description will describe the differences between the present embodiment and the first embodiment, and repeated details will be omitted. In the tumbler 10A of this embodiment, a bottle portion 21A of a tumbler body 20A further includes a bottle base 216, and the bottle base 216 and the inner bottle part 211 of the bottle portion 21A together form a first accommodating space 214A. The lifting component 30 of the tumbler 10A is located in the first accommodating space 214A, and divides the first accommodating space 214A into a first subspace 2141A and a second subspace 2142A. The first accommodating space 214A is configured to accommodate the brewed beverage 300, and the second subspace 2142A is configured to accommodate the brewing substance 200. In addition, the lower cover 213 is assembled on the bottle portion 21A, and covers the sliding recess 215. That is, the lower cover 213 does not form the second accommodating space, and the brewing substance 200 is required to be placed into the tumbler 10A through a mouth thereof.

In this embodiment, the lifting component 30 can be raised or lowered relative to the bottle portion 21A to be moved to the brewing position or the drinking position via the magnetic force. When the manipulated component 40 forces the lifting component 30 to be raised to the brewing position, the separating portion 32 is detached from the lower blocking portion 22, and the first subspace 2141A and the second subspace 2142A respectively located on opposite two sides of the lifting component 30 are in fluid communication with each other via the hollow portion 31. Therefore, the hot water can continuously brew the brewing substance 200. When the manipulated component 40 forces the lifting component 30 to be lowered to the drinking position, the separating portion 32 presses against the lower blocking portion 22 to from a separating structure together with the lower blocking portion 22, and the fluid communication with between the first subspace 2141A and the second subspace 2142A respectively located on opposite two sides of the lifting component 30 are blocked by the separating structure blocking the hollow portion 31. Therefore, the brewed beverage 300 is separated from the brewing substance 200, thereby terminating the brewing process for the brewing substance 200.

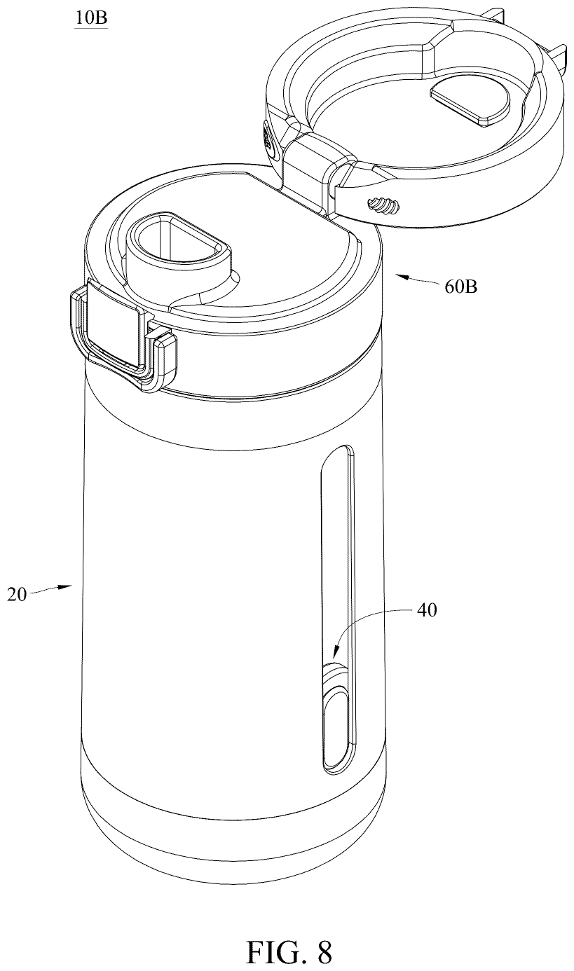

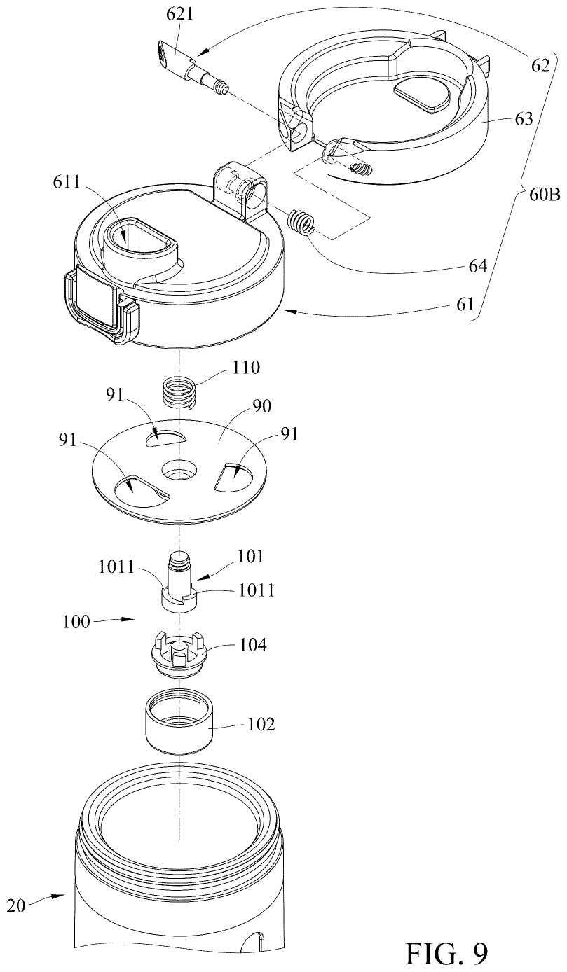

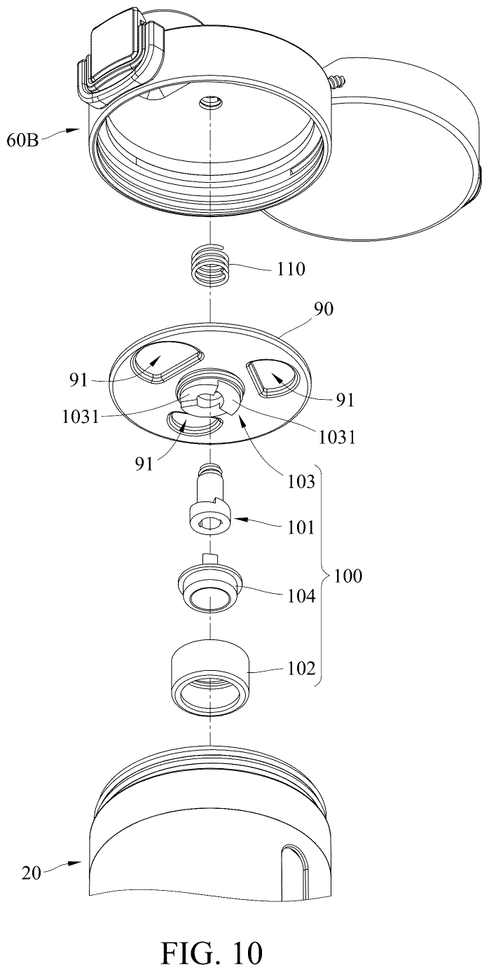

Please refer to FIG. 8 to FIG. 10, where FIG. 8 is a perspective view of a tumbler in accordance with a third embodiment of the present disclosure, FIG. 9 is a partially exploded view of a part of the tumbler in FIG. 8, and FIG. 10 is a partially exploded view of a part of the tumbler in FIG. 8 from another viewing angle.

The tumbler 10B of the present embodiment is similar to the tumbler 10 of the first embodiment. Accordingly, the following description will describe the differences between the present embodiment and the first embodiment, and repeated details will be omitted. In this embodiment, an upper cover 60B of the tumbler 10B includes an assembling base 61, a pivot 62, a cover body 63 and an elastic component 64. The assembling base 61 is, for example, screwed to the bottle portion 21, and has a spout 611. The cover body 63 is pivotally disposed on the assembling base 61 via the pivot 62 to close the spout 611, thereby preventing the brewed beverage 300 from flowing out of the tumbler 10B through the spout 611. The pivot 62 has a helical protrusion 621. The elastic component 64 is sleeved over the pivot 62. Two opposite ends of the elastic component 64 press against the helical protrusion 621 and the cover body 63, respectively. The elastic component 64 is, for example, a spring. The elastic component 64 and the pivot 62 are located in the assembling base 61, and are not exposed externally.

The tumbler 10B includes a flow regulating component 90, a push-push telescopic structure 100 and a restoring component 110. The flow regulating component 90 has three connecting holes 91. Sizes of the connecting holes 91 are different. The flow regulating component 90 is rotatably disposed on the assembling base 61, such that one of the connecting holes 91 is selectively aligned with the spout 611. The push-push telescopic structure 100 includes an assembling post 101, a sleeve 102, a rotating component 103 and a pressing component 104. The assembling post 101 is, for example, screwed to the assembling base 61. The sleeve 102 and the rotating component 103 are fixed to the flow regulating component 90, and the sleeve 102 surrounds the rotating component 103. The pressing component 104 is slidably located in the sleeve 102. The assembling post 101 and the rotating component 103 has a plurality of guide blocks 1011 and 1031 matching each other, respectively. The pressing component 104 is pressably disposed on the rotating component 103, and the pressing component 104 forces the flow regulating component 90 to be rotated via the guide blocks 1011 and 1031 matching each other and the rotating component 103. Two opposite ends of the restoring component 110 press against the assembling base 61 and the flow regulating component 90, respectively, thereby allowing the pressing component 104 to be restored after being pressed. The restoring component 110 is, for example, a spring.

In this embodiment, there are multiple guide blocks 1011 of the assembling post 101 and multiple guide blocks 1031 of the rotating component 103 matching each other, and the flow regulating component 90 is forced to be rotated via the guide blocks 1011 and 1031, but the present disclosure is not limited thereto. In other embodiment, there may be one guide block of the assembling post and one guide block of the rotating component, and the two guide blocks match each other to force the flow regulating component 90 to be rotated via the guide blocks.

In this embodiment, there are three connecting holes 91. The sizes of the connecting holes 91 are different, and one of the connecting holes 91 is selectively aligned with the spout 611, but the present disclosure is not limited thereto. In other embodiment, there may two or more than three connecting holes of different sizes, and one of the connecting holes is selectively aligned with the spout.

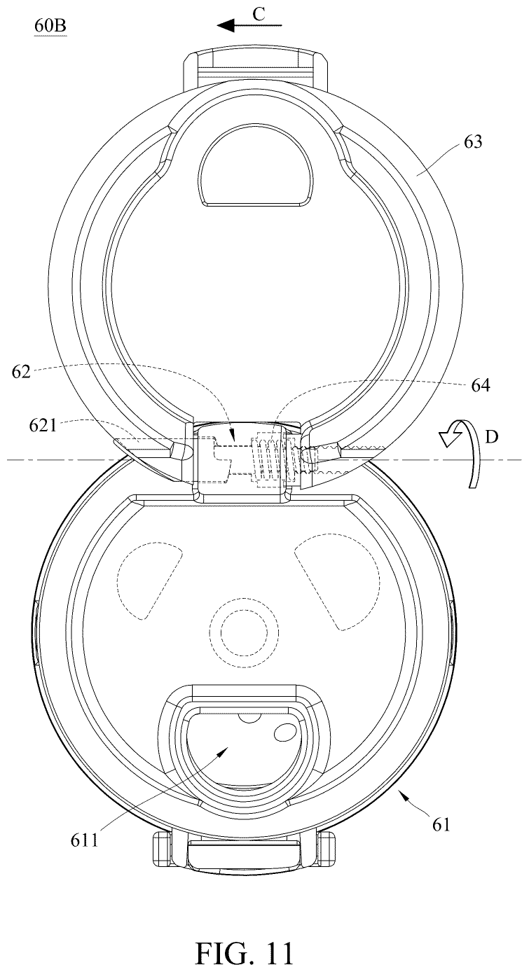

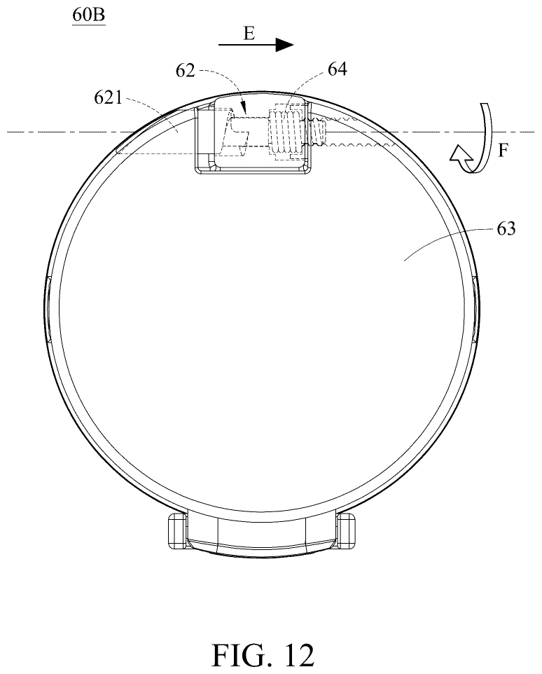

Please refer to FIG. 11 and FIG. 12, where FIG. 11 is a top view showing that the upper cover in FIG. 8 is opened, and FIG. 12 is a top view showing that the upper cover in FIG. 8 is closed.

In this embodiment, when the upper cover 60B is located at a closing position, two opposite ends of the elastic component 64 press against the helical protrusion 621 and the cover body 63, respectively. As shown in FIG. 11, when the user is required to open the upper cover 60B, the helical protrusion 621 of the pivot 62 forces the elastic component 64 to be extended along a direction C. Accordingly, the upper cover 60B can be opened by being moved from the closing position to an opening position along a direction D. As shown in FIG. 12, when the user is required to close the upper cover 60B, the helical protrusion 621 of the pivot 62 presses the elastic component 64 along a direction E. Accordingly, the upper cover 60B can be closed by being moved from the opening position to the closing position along a direction F.

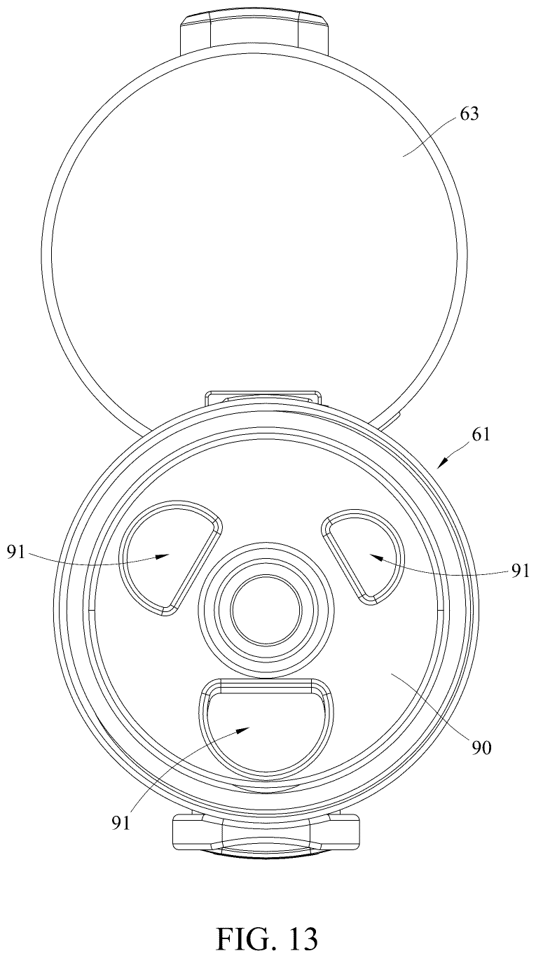

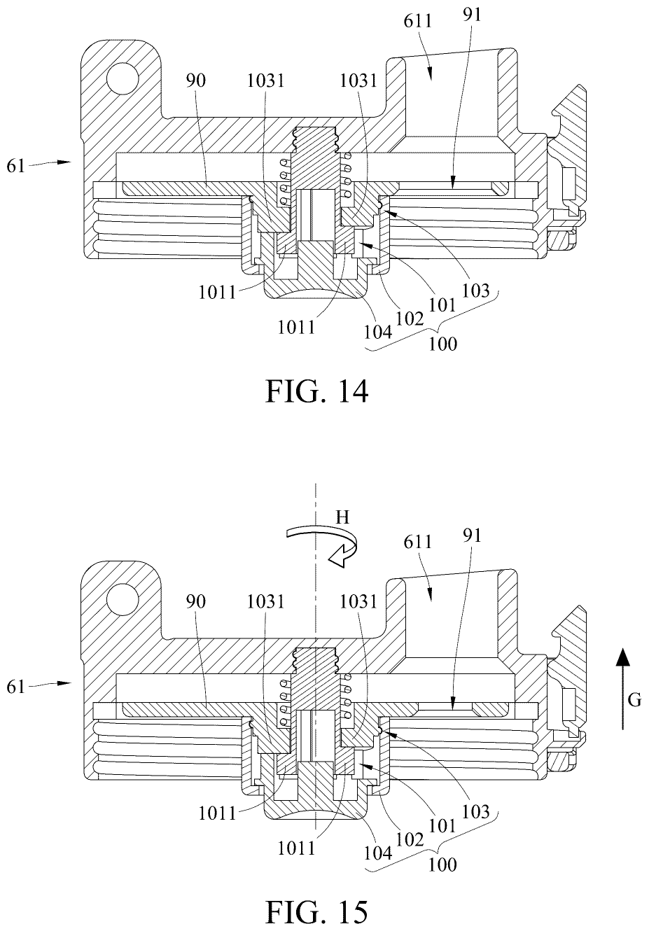

Please refer to FIG. 13 to FIG. 15, where FIG. 13 is a bottom view of the upper cover in FIG. 8, FIG. 14 is a cross-sectional view of the upper cover in FIG. 8, and FIG. 15 is a cross-sectional view showing that the push-push telescopic structure in FIG. 8 is rotated.

In this embodiment, one of the connecting holes 91 having different sizes is in fluid communication with the spout 611. When the user selects the connecting hole 91 with suitable size according to his/her requirement, the user can press the pressing component 104 along a direction G, such that the flow regulating component 90 and the restoring component 110 are pressed by the pressing component 104 to be moved along the direction G. Then, the user releases the pressing component 104, such that the assembling post 101 and the guide blocks 1011 and 1031 of the rotating component 103 force the flow regulating component 90 to be rotated along a direction H, and the restoring component 110 restores along a direction opposite to the direction G. At this time, another connecting hole 91 with suitable size according to the his/her requirement can be in fluid communication with the spout 611. Therefore, the user can adjust the flow regulating component 90 according to his/her requirement to select the connecting hole 91 with suitable size.

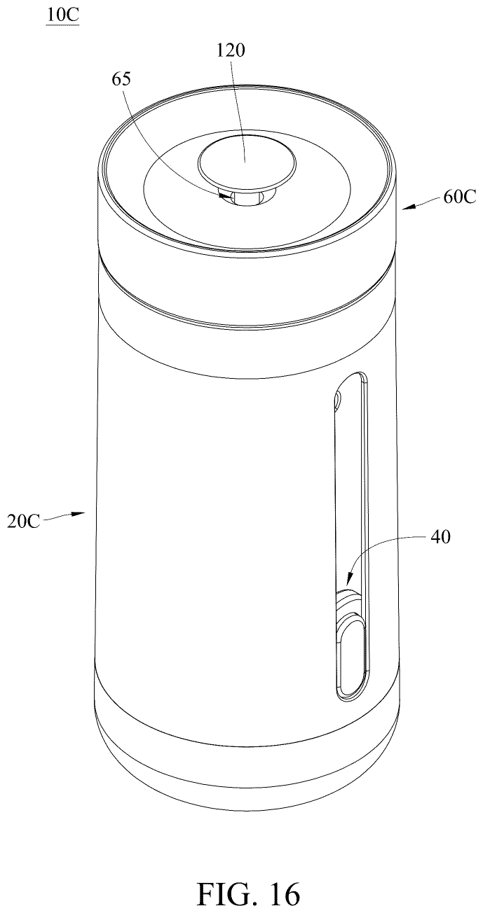

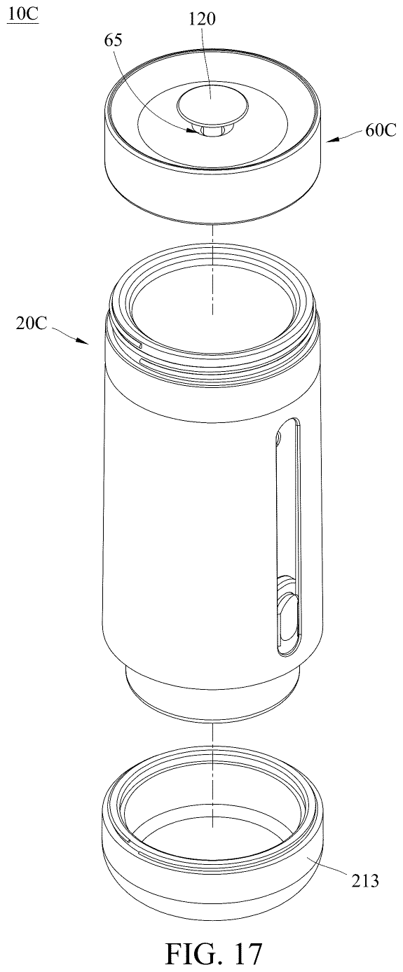

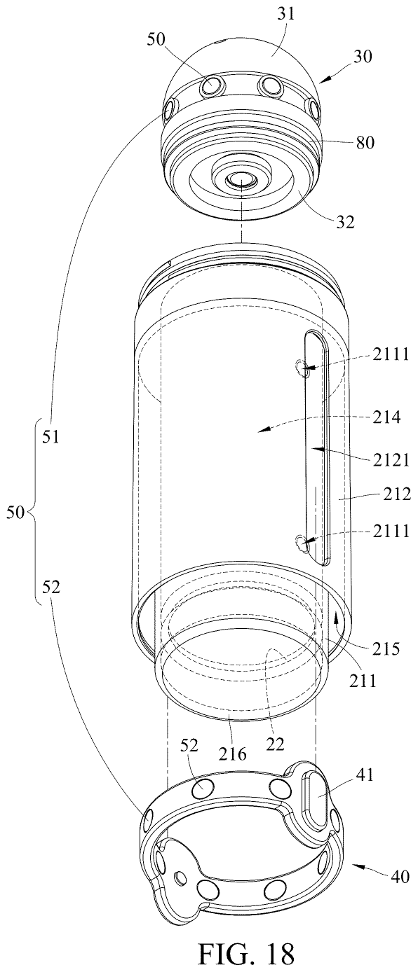

Please refer to FIG. 16 to FIG. 18, where FIG. 16 is a perspective view of a tumbler in accordance with a fourth embodiment of the present disclosure, FIG. 17 is an exploded view of the tumbler in FIG. 16, and FIG. 18 is a partially exploded view of the tumbler in FIG. 16.

The tumbler 10C of the present embodiment is similar to the tumbler 10 of the first embodiment. Accordingly, the following description will describe the differences between the present embodiment and the first embodiment, and repeated details will be omitted. In this embodiment, the tumbler 10C includes a closure component 120 and a filter component 130. The upper cover 60C has an air hole 65. The closure component 120 is movably disposed at the air hole 65 to close the air hole 65 or open the air hole 65. The lifting component 30 of the tumbler 10C is located in a first accommodating space 214C, and the filter component 130 is disposed through the hollow portion 31 of the lifting component 30. The filter component 130 is, for example, an iron mesh, and is configured to filter the brewing substance 200. In addition, each of two opposite sides of the inner bottle part 211 has two positioning recesses 2111, and the two positioning recesses 2111 corresponding to two opposite ends of the openings 2121, such that the lifting component 30 can be held in position at the positioning recesses 2111 when the lifting component 30 is raised or lowered via the magnetic force.

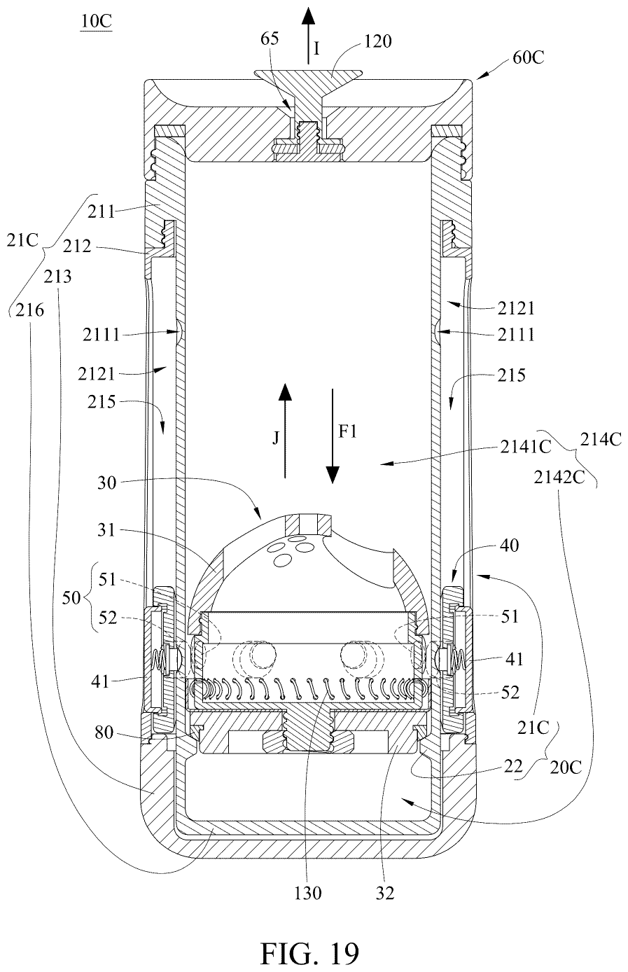

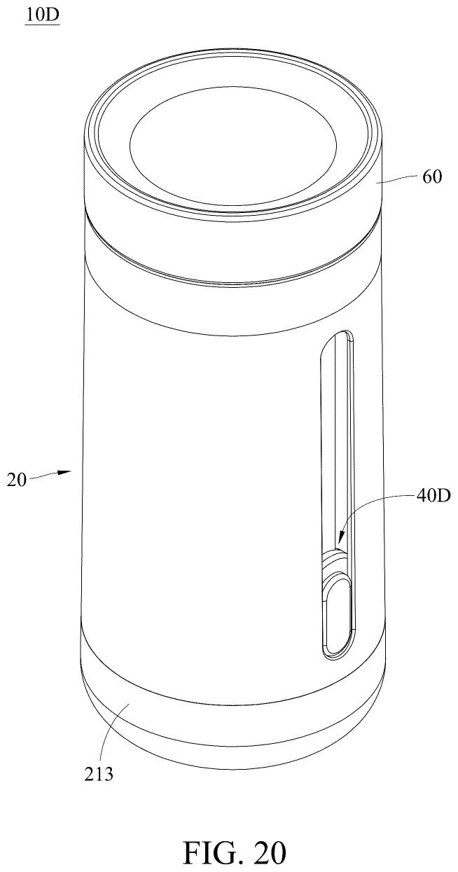

Please refer to FIG. 16 to FIG. 19, where FIG. 19 is a cross-sectional view of the tumbler in FIG. 16. In this embodiment, when the user is required to drink the brewed beverage 300 including milk foam or froth, the user can firstly move the closure component 120 along a direction I, such that the air located outside the tumbler 10C can flow into the first accommodating space 214C of the tumbler 10C through the air hole 65 of the upper cover 60C. Then, the user can quickly and repeatedly move the lifting component 30 along a direction J and a direction opposite to the direction J via the manipulated component 40, thereby injecting the air located outside the tumbler 10C into the brewed beverage 300 in the tumbler 10C through the air hole 65. Accordingly, the milk foam or the froth can be generated in the brewed beverage 300.

In this embodiment, the lifting component 30 may be moved between the brewing position and the drinking position relative to the bottle portion 21C via the magnetic force. When the manipulated portion 41 of the manipulated component 40 is not pressed, the manipulated component 40 can be held in position at the inner bottle part 211 by, for example, allowing the manipulated component 40 to be held at a current position via a positioning protrusion thereof manipulated component positioned at the inner bottle part 211 manipulated component. When the manipulated portion 41 of the manipulated component 40 is pressed, the manipulated component 40 can be moved relative to the inner bottle part 211 to be released by, for example, forcing the manipulated component 40 to be detached from the inner bottle part 211 via the compression of a spring connected to the manipulated portion 41, and the manipulated component 40 can force the lifting component 30 to be raised or lowered relative to the inner bottle part 211.

When the manipulated component 40 forces the lifting component 30 to be raised to the brewing position, the manipulated portion 41 of the manipulated component 40 can be held in position at the positioning recesses 2111 corresponding to a top end of the openings 2121. In addition, the separating portion 32 of the lifting component 30 is detached from the lower blocking portion 22 of the tumbler body 20, and a first subspace 2141C and a second subspace 2142C respectively located on opposite two sides of the lifting component 30 are in fluid communication with each other via the hollow portion 31. Therefore, the hot water can continuously brew the brewing substance 200. When the manipulated component 40 forces the lifting component 30 to be lowered to the drinking position, the manipulated portion 41 of the manipulated component 40 can be held in position at the positioning recesses 2111 corresponding to a bottom end of the openings 2121. In addition, the separating portion 32 of the lifting component 30 presses against the lower blocking portion 22 of the tumbler body 20 to from the separating structure together with the lower blocking portion 22, and the fluid communication with between the first subspace 2141C and the second subspace 2142C respectively located on opposite two sides of the lifting component 30 blocked by the separating structure blocking the hollow portion 31. Therefore, the brewed beverage 300 is separated from the brewing substance 200, thereby terminating the brewing process for the brewing substance 200.

In addition, when the manipulated component 40 forces the lifting component 30 to be raised to the drinking position and the manipulated portion 41 of the manipulated component 40 is held in position at the positioning recesses 2111, a central portion of the first magnetic components 51 is farther away from the lower cover 213 than a central portion of the second magnetic components 52. That is, the first magnetic components 51 and the second magnetic components 52 are misaligned. At this time, the magnetic force generated between the first magnetic components 51 and the second magnetic components 52 which are misaligned can apply a force F1 on the manipulated component 40 toward the lower cover 213, such that the lifting component 30 forced by the manipulated component 40 can press against the lower blocking portion 22 of tumbler body 20C more tightly, thereby preventing the brewed beverage 300 from flowing between the first subspace 2141C and the second subspace 2142C.

In this embodiment, a gap between the lifting component 30 and the inner bottle part 211 can be adjusted by adopting lifting components of different sizes, such that a flow rate and a flow velocity of the brewed beverage 300 flowing from the first subspace 2141C to the second subspace 2142C can be controlled.

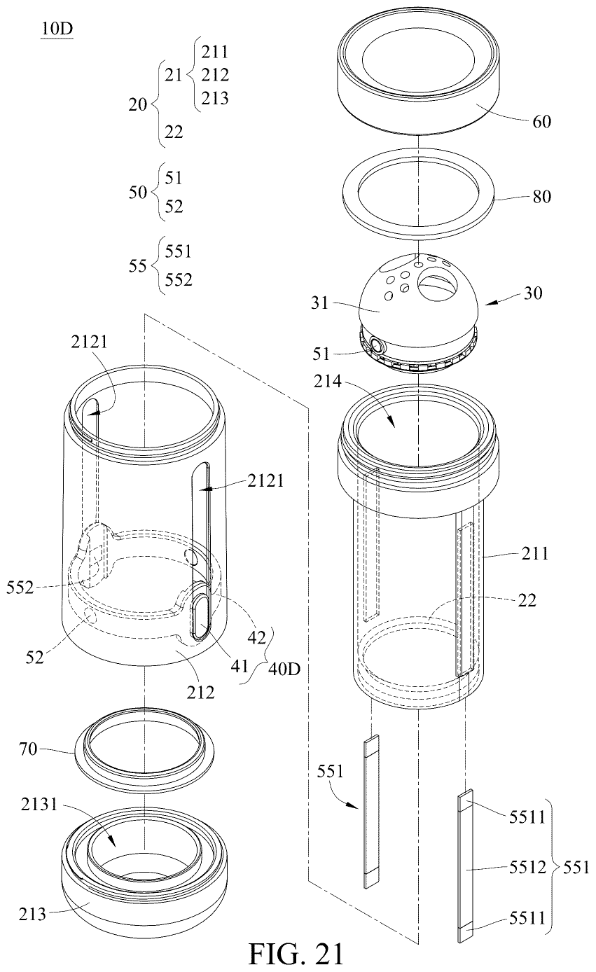

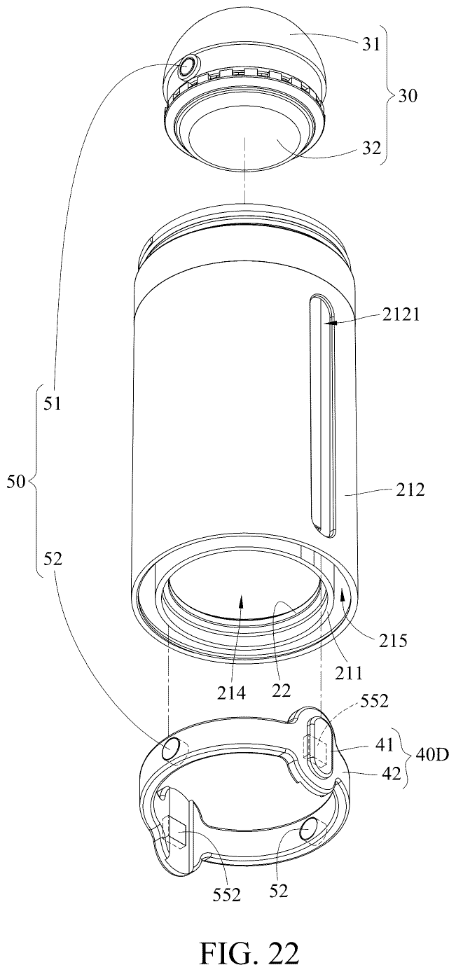

Please refer to FIG. 20 to FIG. 22, where FIG. 20 is a perspective view of a tumbler in accordance with a fifth embodiment of the present disclosure, FIG. 21 is an exploded view of the tumbler in FIG. 20, and FIG. 22 is a partially exploded view of the tumbler in FIG. 20.

The tumbler 10D of the present embodiment is similar to the tumbler 10 of the first embodiment. Accordingly, the following description will describe the differences between the present embodiment and the first embodiment, and repeated details will be omitted. In this embodiment, the tumbler 10D includes a tumbler body 20, a lifting component 30, a manipulated component 40D, a first magnetic assembly 50, a second magnetic assembly 55 and an upper cover 60. The tumbler body 20 includes a bottle portion 21 and a lower blocking portion 22. The bottle portion 21 includes an inner bottle part 211, an outer bottle base 212 and a lower cover 213. The inner bottle part 211 forms a first accommodating space 214. The outer bottle base 212 is sleeved over the inner bottle part 211 and assembled thereon to form a double-layered thermal insulation structure together with the inner bottle part 211. A sliding recess 215 is formed between the outer bottle base 212 and the inner bottle part 211. The sliding recess 215 is spaced apart from the first accommodating space 214. Two opposite sides of the outer bottle base 212 has an opening 2121. The openings 2121 are connected to the sliding recess 215.

The lower cover 213 is, for example, detachably screwed to the bottle portion 21, and covers the sliding recess 215 and the first accommodating space 214. The lower cover 213 forms a second accommodating space 2131. The second accommodating space 2131 is configured to accommodate the brewing substance 200, such as tea leaves. After the brewing substance 200 is placed into the second accommodating space 2131, a hot water can be poured into the tumbler body 20 to brew a brewed beverage 300, such as a tea, in the first accommodating space 214. The lower blocking portion 22 protrudes from a bottom side of the bottle portion 21, and is located in the first accommodating space 214.

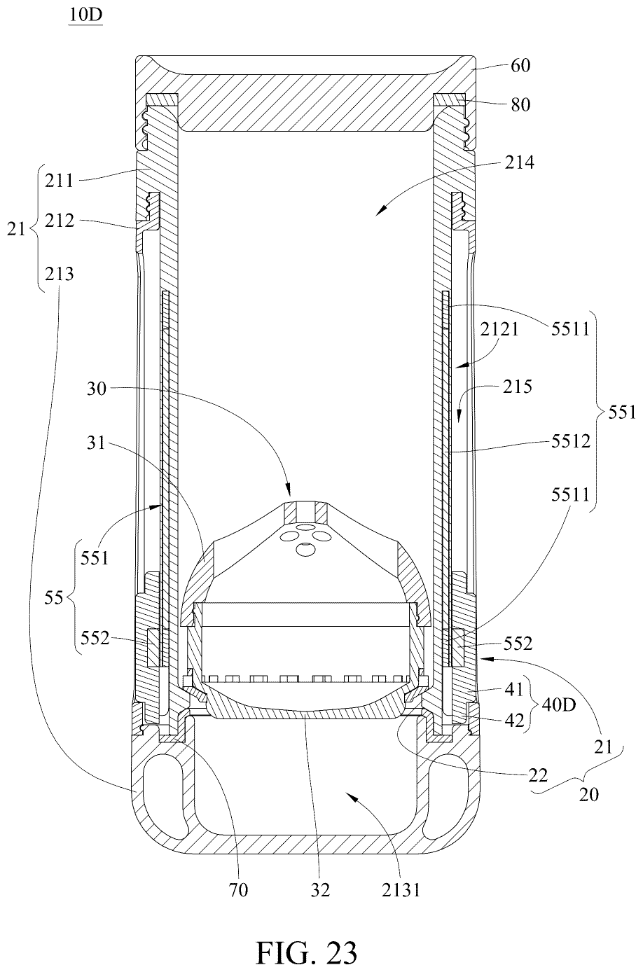

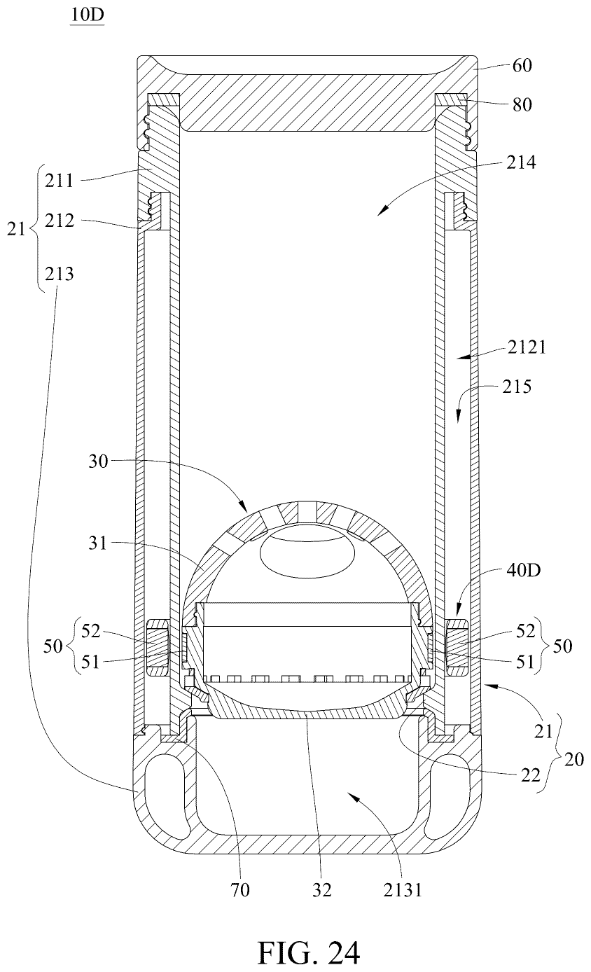

Please refer to FIG. 20 to FIG. 24, where FIG. 23 is a cross-sectional view of the tumbler in FIG. 20, and FIG. 24 is a cross-sectional view of the tumbler in FIG. 20 from another viewing angle.

The lifting component 30 is located in the first accommodating space 214, and includes a hollow portion 31 and a separating portion 32. The hollow portion 31 is connected to the separating portion 32. The hollow portion 31 has a plurality of holes, such that the first accommodating space 214 can be in fluid communication with the second accommodating space 2131 via the holes of the hollow portion 31. The separating portion 32 is configured to press against the lower blocking portion 22 of the tumbler body 20, thereby blocking the fluid communication between the first accommodating space 214 and the second accommodating space 2131. The separating portion 32 is made of, for example, elastic material.

The manipulated component 40D is located outside the first accommodating space 214. The manipulated component 40D is movably disposed on the bottle portion 21 along an axial direction thereof. The manipulated component 40D includes an annual portion 42 and two manipulated portions 41. The two manipulated portions 41 are disposed on two opposite sides of the annual portion 42, respectively, and are located at the two openings 2121 of the outer bottle base 212, respectively. The first magnetic assembly 50 includes a plurality of first magnetic components 51 and a plurality of second magnetic components 52. The first magnetic components 51 and the second magnetic components 52 are, for example, magnets. The first magnetic components 51 are disposed on the lifting component 30. The second magnetic components 52 are disposed on the manipulated component 40D. The second magnetic components 52 attract the first magnetic components 51, respectively, such that the manipulated component 40D can force the lifting component 30 to be moved relative to the bottle portion 21 via a magnetic force.

The upper cover 60 is, for example, detachably screwed to a top side of the tumbler body 20. The upper cover 60 and the lower cover 213 are located on two opposite ends of the first accommodating space 214 and the second accommodating space 2131, respectively. The upper cover 60 covers the first accommodating space 214.

The second magnetic assembly 55 includes two third magnetic components 551 and two fourth magnetic components 552. The two third magnetic components 551 are disposed on the inner bottle part 211. Each of the third magnetic components 551 includes two attracting portions 5511 and a repelling portion 5512. The two attracting portions 5511 are disposed on two opposite ends of the repelling portion 5512, respectively, and correspond to the brewing position and the drinking position, respectively. The two fourth magnetic components 552 disposed on the two manipulated portions 41, respectively, and the inner bottle part 211 is located between the third magnetic components 551 and the fourth magnetic components 552. bottle portion A magnetic pole of the two attracting portions 5511 is different from a magnetic pole of the two fourth magnetic components 552, and the two attracting portions 5511 attract the two fourth magnetic components 552, thereby holding the manipulated component 40D and the lifting component 30 at the brewing position or the drinking position. A magnetic pole of the repelling portion 5512 is identical to the magnetic pole of the two fourth magnetic components 552, and the repelling portion 5512 repels the two fourth magnetic component 552. Accordingly, when the two fourth magnetic components 552 is moved relative to the repelling portion 5512, a frictional force generated therebetween can be reduced via a repelling force generated between the repelling portion 5512 and the two fourth magnetic components 552, such that the manipulated component 40D and the lifting component 30 can be moved smoothly between the brewing position and the drinking position.

In this embodiment, the lifting component 30 may be moved between the brewing position and the drinking position relative to the bottle portion 21 via the magnetic force. When the manipulated component 40D forces the lifting component 30 to be raised to the brewing position, the separating portion 32 is detached from the lower blocking portion 22, and the first accommodating space 214 and the second accommodating space 2131 respectively located on opposite two sides of the lifting component 30 are in fluid communication with each other via the hollow portion 31. Therefore, the hot water can continuously brew the brewing substance 200. When the manipulated component 40D forces the lifting component 30 to be lowered to the drinking position, the separating portion 32 presses against the lower blocking portion 22 to from a separating structure together with the lower blocking portion 22, and the fluid communication between, and the first accommodating space 214 and the second accommodating space 2131 respectively located on opposite two sides of the lifting component 30 blocked by the separating structure blocking the hollow portion 31. Therefore, the brewed beverage 300 is separated from the brewing substance 200, thereby terminating the brewing process for the brewing substance 200. Accordingly, the user can regulate the concentration of the brewed beverage 300 according to the preference thereof via the lifting component 30 located at the brewing position or the drinking position.

In addition, in the conventional tumbler, the manipulated component forcing the lifting component to be moved is located close to a mouth of the bottle portion. Therefore, during the brewing process, the user cannot close the upper cover onto the tumbler body until the brewing process is completed. On the contrary, in this embodiment, since the manipulated component 40D forcing the lifting component 30 to be moved is located on two opposite sides of the tumbler body 20, the manipulated component 40D does not obstruct the upper cover 60 from being closed onto the tumbler body 20. As a result, when the user is in a hurry to go out, the user can firstly close the upper cover 60 onto the tumbler body 20, and then moves the lifting component 30 to the brewing position via the manipulated component 40D while on the go. Accordingly, the user does not require to spend additional time waiting for the brewed beverage 300 to finish the brewing, thereby saving the brewing time and improving the convenience of beverage preparation.

Moreover, the tumbler 10D includes the second magnetic assembly 55, and the manipulated component 40D and the lifting component 30 are held at the brewing position or the drinking position via the magnetic attraction between the attracting portions 5511 of the second magnetic assembly 55 and the fourth magnetic components 552. Therefore, the manipulated component 40D and the lifting component 30 can be located at the brewing position or the drinking position more firmly. In addition, the frictional force generated during the movement of the fourth magnetic components 552 relative to the repelling portion 5512 can be reduced via the repelling force generated between the repelling portion 5512 of the second magnetic assembly 55 and the fourth magnetic components 552. Therefore, the manipulated component 40D and the lifting component 30 can be moved more smoothly between the brewing position and the drinking position.

In this embodiment, the tumbler 10D may include a first sealing pad 70. The first sealing pad 70 is, for example, a rubber ring. The first sealing pad 70 is clamped between the lower cover 213 and the bottle portion 21. Accordingly, a sealing performance between the lower cover 213 and the bottle portion 21 can be improved by the first sealing pad 70, thereby preventing the brewed beverage 300 from leaking out from a gap therebetween.

In this embodiment, the tumbler 10D may include a second sealing pad 80. The second sealing pad 80 is, for example, a rubber ring. The second sealing pad 80 is clamped between the upper cover 60 and the bottle portion 21. Accordingly, a sealing performance between the separating portion 32 and the lower blocking portion 22 can be improved by the second sealing pad 80, thereby preventing the brewed beverage 300 from flowing from the first accommodating space 214 to the second accommodating space 2131.

In this embodiment, there are multiple first magnetic components 51 and multiple second magnetic components 52, but the present disclosure is not limited thereto. In other embodiment, there may be one first magnetic component and one second magnetic component.

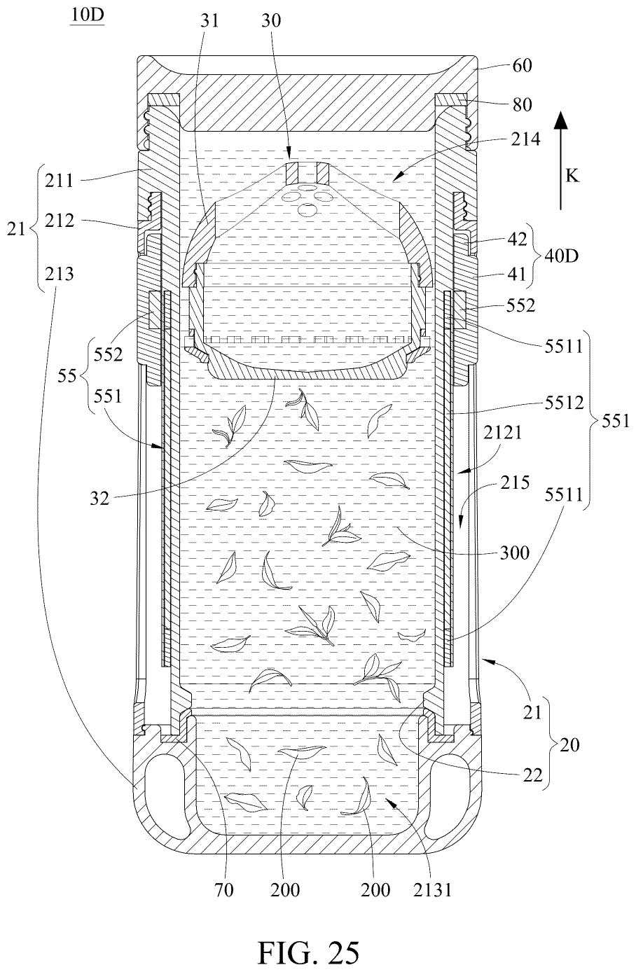

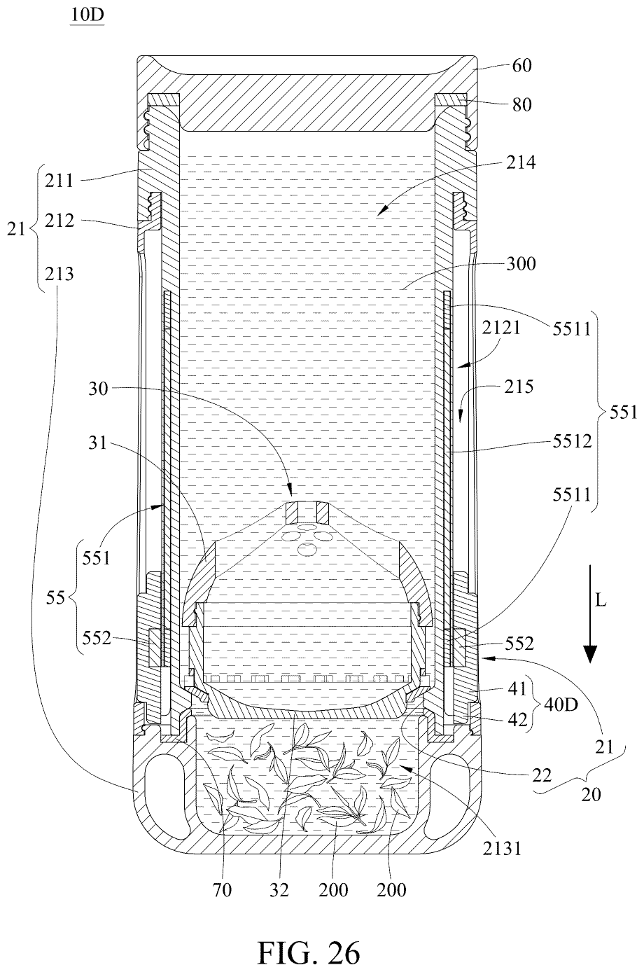

Please refer to FIG. 25 and FIG. 26, where FIG. 25 is a cross-sectional view of the lifting component in FIG. 20 located at the brewing position, and FIG. 26 is a cross-sectional view of the lifting component in FIG. 20 located at the drinking position.

As shown in FIG. 25, when the user is required to brew the tea, the user may place the brewing substance 200 into the second accommodating space 2131 of the lower cover 213 and screw the lower cover 213 to the bottle portion 21, such that the first accommodating space 214 of the bottle portion 21 is in fluid communication with the second accommodating space 2131. Accordingly, the brewed beverage 300 may be brewed via the brewing substance 200 steeped in the hot water. Then, the user presses the manipulated portion 41 of the manipulated component 40D, such that the manipulated component 40D forces the lifting component 30 to be raised to the brewing position along a direction K via the magnetic force generated between the first magnetic components 51 and the second magnetic components 52. At this time, the manipulated component 40D and the lifting component 30 are moved relative to the tumbler body 20 smoothly via the repelling force generated between the repelling portion 5512 and the fourth magnetic components 552, and are positioned at the brewing position via the magnetic attraction between the attracting portions 5511 and the fourth magnetic components 552, and the hot water is poured into the tumbler body 20 to steep the brewing substance 200 in the hot water to brew the brewed beverage 300. At this time, the brewed beverage 300 can flow between the first accommodating space 214 and the second accommodating space 2131 via the hollow portion 31 of the lifting component 30.

As shown in FIG. 26, when the user feels that a concentration of the brewed beverage 300 meets his/her preference, the user can press the manipulated portion 41 of the manipulated component 40D, such that the manipulated component 40D forces the lifting component 30 to be lowered from the brewing position to the drink position along a direction L via the magnetic force generated between the first magnetic components 51 and the second magnetic components 52. At this time, the manipulated component 40D and the lifting component 30 are moved relative to the tumbler body 20 smoothly via the repelling force generated between the repelling portion 5512 and the fourth magnetic components 552, and are positioned at the drinking position via the magnetic attraction between the attracting portions 5511 and the fourth magnetic components 552. When the lifting component 30 is located at the drinking position, the separating portion 32 of the lifting component 30 presses against the lower blocking portion 22 of the tumbler body 20, and blocks the fluid communication between the first accommodating space 214 and the second accommodating space 2131, thereby preventing the brewed beverage 300 brewed with the brewing substance 200 located in the second accommodating space 2131 from flowing to the first accommodating space 214. That is, the concentration of the brewed beverage 300 located in the first accommodating space 214 is prevented from being increased over time due to prolonged brewing.

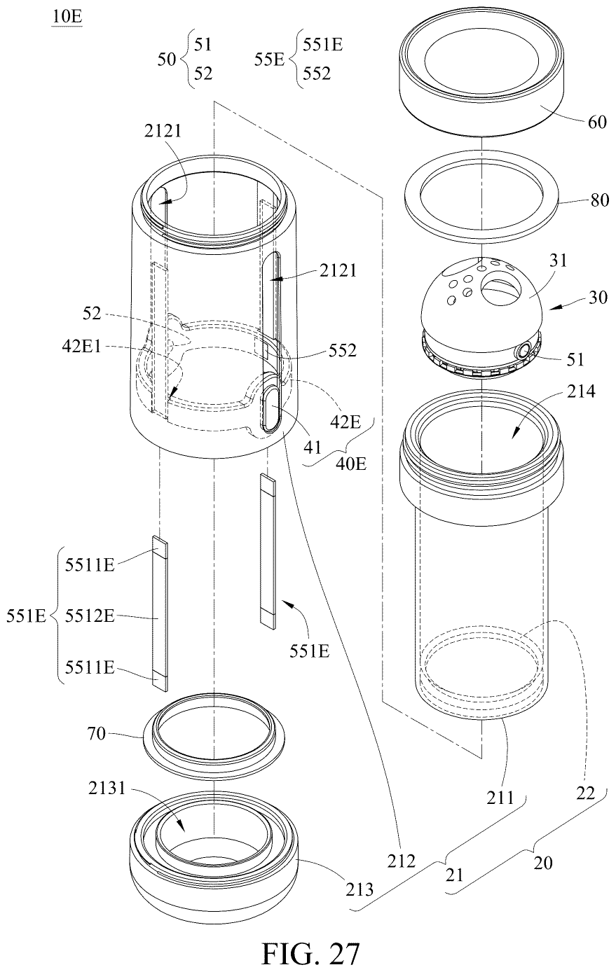

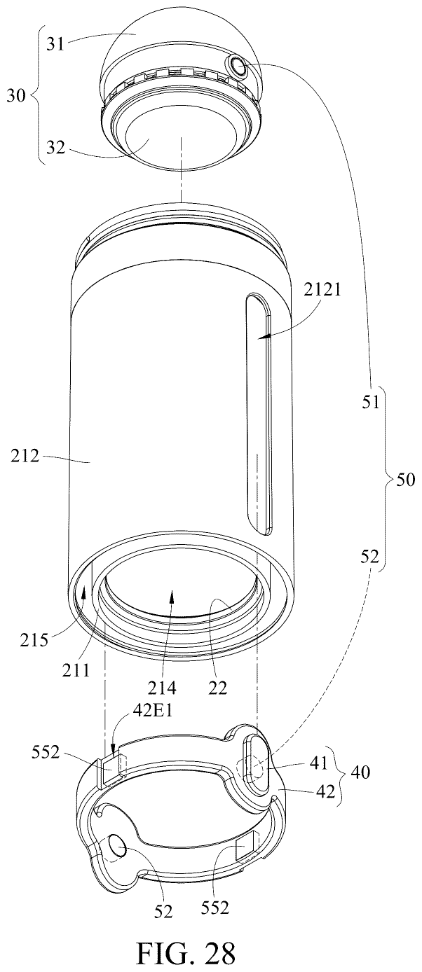

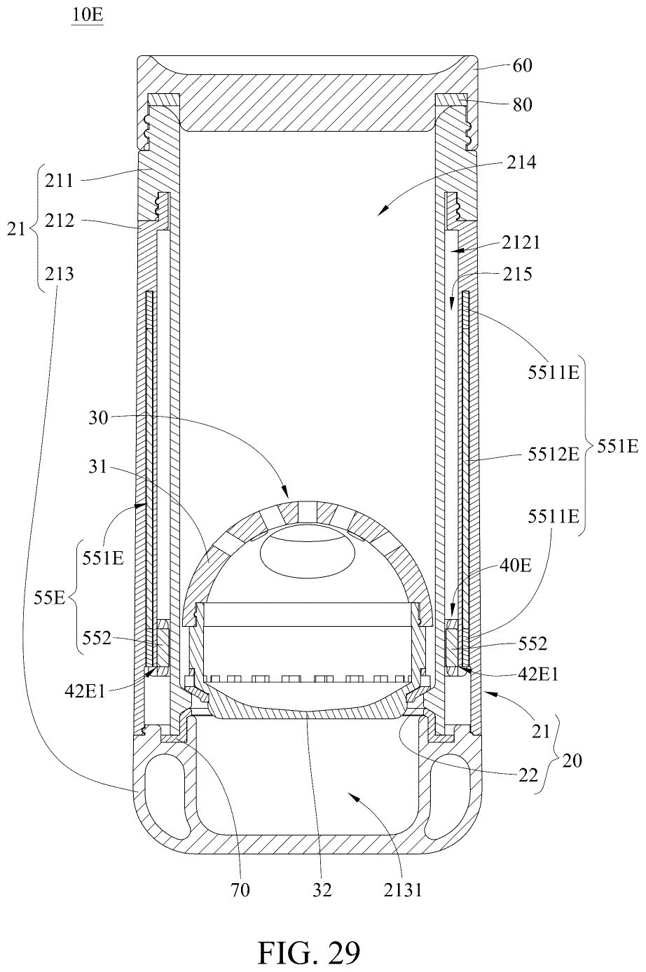

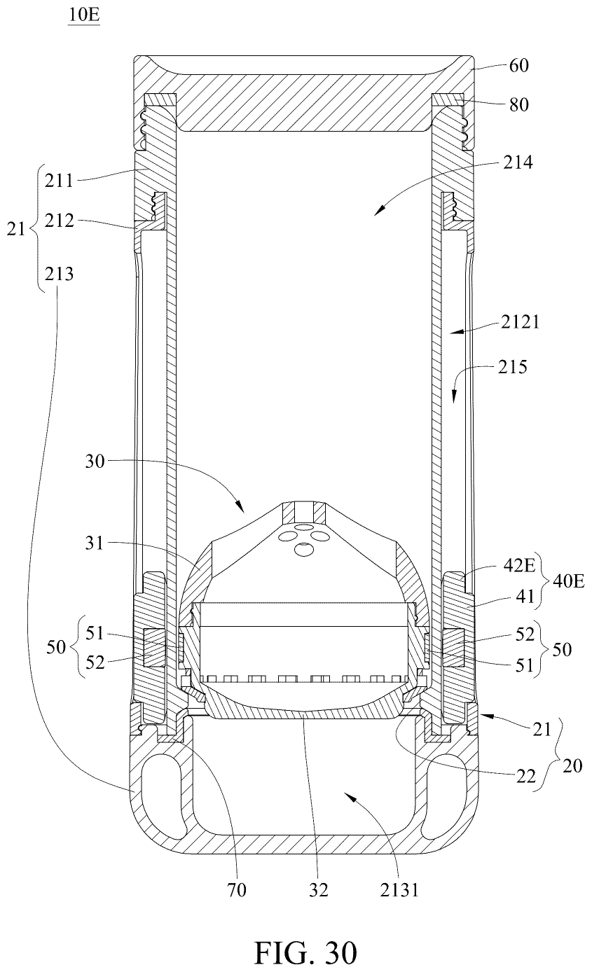

In this embodiment, the third magnetic components 551 are disposed on the inner bottle part 211, and the fourth magnetic components 552 are disposed on the manipulated portions 41 of the manipulated component 40D, respectively, but the present disclosure is not limited thereto. In other embodiment, please refer to FIG. 27 and FIG. 30, where FIG. 27 is an exploded view of a tumbler in accordance with a sixth embodiment of the present disclosure, FIG. 28 is a partially exploded view of the tumbler in FIG. 27, FIG. 29 is a cross-sectional view of the tumbler in FIG. 27, and FIG. 30 is a cross-sectional view of the tumbler in FIG. 27 from another viewing angle.

The tumbler 10E of the present embodiment is similar to the tumbler 10D of the fifth embodiment. Accordingly, the following description will describe the differences between the present embodiment and the first embodiment, and repeated details will be omitted. In the tumbler 10E of this embodiment, third magnetic components 551E of a second magnetic assembly 55E are disposed on the outer bottle base 212. A annual portion 42E of a manipulated component 40E has two slots 42E1. The two fourth magnetic components 552 are disposed in two slots 42E1, respectively.

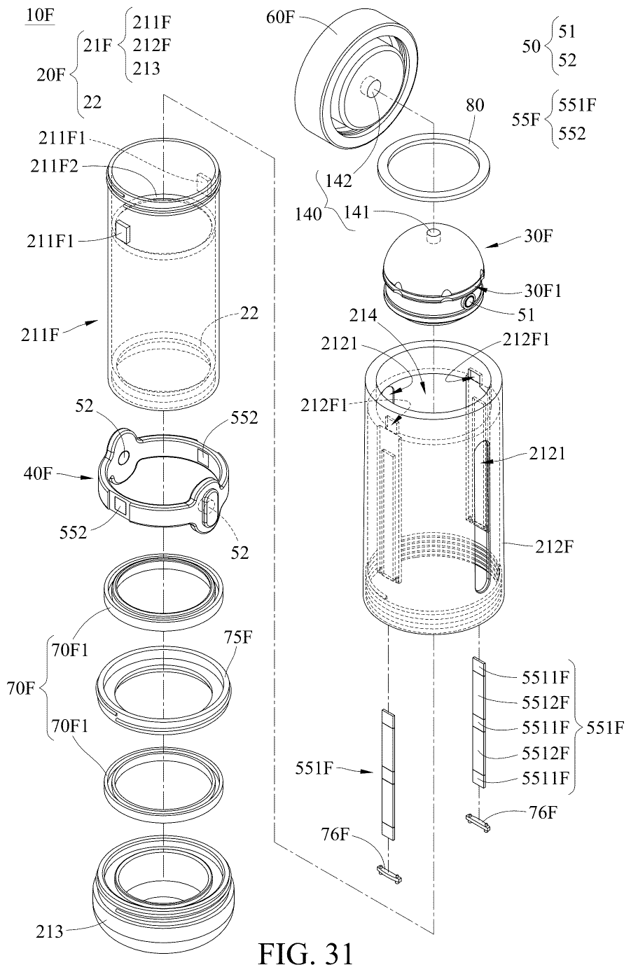

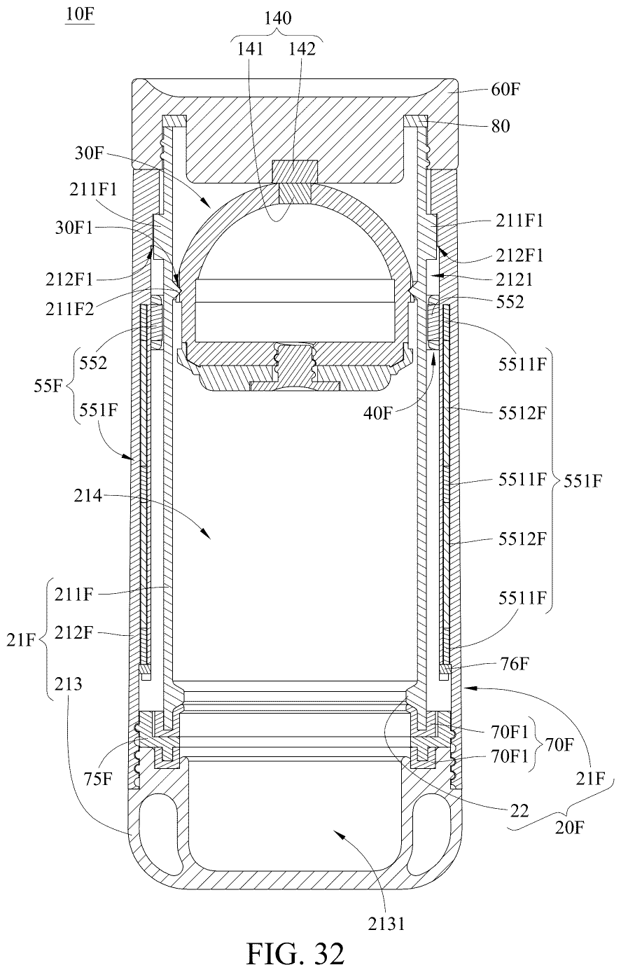

Please refer to FIG. 31 and FIG. 32, where FIG. 31 is an exploded view of a tumbler in accordance with a seventh embodiment of the present disclosure, and FIG. 32 is a cross-sectional view of the tumbler in FIG. 31. The tumbler 10F of the present embodiment is similar to the tumbler 10D of the fifth embodiment. Accordingly, the following description will describe the differences between the present embodiment and the first embodiment, and repeated details will be omitted.

In the tumbler 10F of this embodiment, an inner bottle part 211F includes a first positioning structure 211F1. An outer bottle base 212F includes a second positioning structure 212F1. For example, the first positioning structure 211F1 is a positioning protrusion, and the second positioning structure 212F1 is a positioning recess. In detail, the first positioning structure 211F1 and the second positioning structure 212F1 are a protrusion and a recess matching each other. Accordingly, when the outer bottle base 212F is assembled on the inner bottle part 211F, the inner bottle part 211F can be held in position within the outer bottle base 212F via the first positioning structure 211F1 and the second positioning structure 212F1.

In this embodiment, the inner bottle part 211F includes a third positioning structure 211F2. The lifting component 30F includes a fourth positioning structure 30F1. For example, the third positioning structure 211F2 is a positioning protrusion, and the fourth positioning structure 30F1 is a positioning recess. In detail, the third positioning structure 211F2 and the fourth positioning structure 30F1 are a protrusion and a recess matching each other. Accordingly, the lifting component 30F can be held at the drinking position via the third positioning structure 211F2 and the fourth positioning structure 30F1 when the lifting component 30F is moved thereto.

In this embodiment, the tumbler 10F includes a third magnetic assembly 140. The third magnetic assembly 140 includes a fifth magnetic component 141 and a sixth magnetic component 142. The fifth magnetic component 141 is disposed on the lifting component 30F. The sixth magnetic component 142 is disposed on the upper cover 60F. The fifth magnetic component 141 is configured to attract the sixth magnetic component 142. Accordingly, when the lifting component 30F is moved to the drinking position, the lifting component 30F can be further held in position via the magnetic attraction between the fifth magnetic component 141 and the sixth magnetic component 142.

In this embodiment, the tumbler 10F includes a first positioning component 75F and a second positioning component 76F. The first positioning component 75F is clamped between the upper cover 60F and the bottle portion 21F. The first sealing pad 70F includes two sealing portions 70F1, and the sealing portions 70F1 are spaced apart from each other. At least a part of the first positioning component 75F is clamped between the sealing portions 70F1. When the outer bottle base 212F is assembled on the inner bottle part 211F, the inner bottle part 211F can be fixed to the outer bottle base 212F via the first positioning component 75F.

The second positioning component 76F is disposed on attracting portions 5511F of third magnetic components 551F located close to the lower cover 213, and is configured to hold the third magnetic components 551F in position. Accordingly, the third magnetic components 551F can be prevented from being detached from the bottle portion 21F.

In this embodiment, there are, for example, three attracting portions 5511F of each of the third magnetic components 551F and two repelling portions 5512F of each of the third magnetic components 551F. The three attracting portions 5511F and the two repelling portions 5512F are arranged alternately.

In this embodiment, the first positioning structure 211F1 and the second positioning structure 212F1 are the positioning protrusion and the positioning recess, respectively, and match each other, but the present disclosure is not limited thereto. In other embodiment, the recess and protrusion configurations of the first positioning structure and the second positioning structure may be exchanged, such that the first positioning structure and the second positioning structure may be the positioning recess and the positioning protrusion, respectively, and match each other.

In this embodiment, the third positioning structure 211F2 and the fourth positioning structure 30F1 are the positioning protrusion and the positioning recess, respectively, and match each other, but the present disclosure is not limited thereto. In other embodiment, the recess and protrusion configurations of the third positioning structure and the fourth positioning structure may be exchanged, such that the third positioning structure and the fourth positioning structure may be the positioning recess and the positioning protrusion, respectively, and match each other.

In this embodiment, the tumbler 10F includes the second positioning component 76F to position the third magnetic components 551F, but the present disclosure is not limited thereto. In other embodiment, the tumbler may not include the second positioning component, and the third magnetic components may be positioned via, for example, overmolding by a plastic injection.

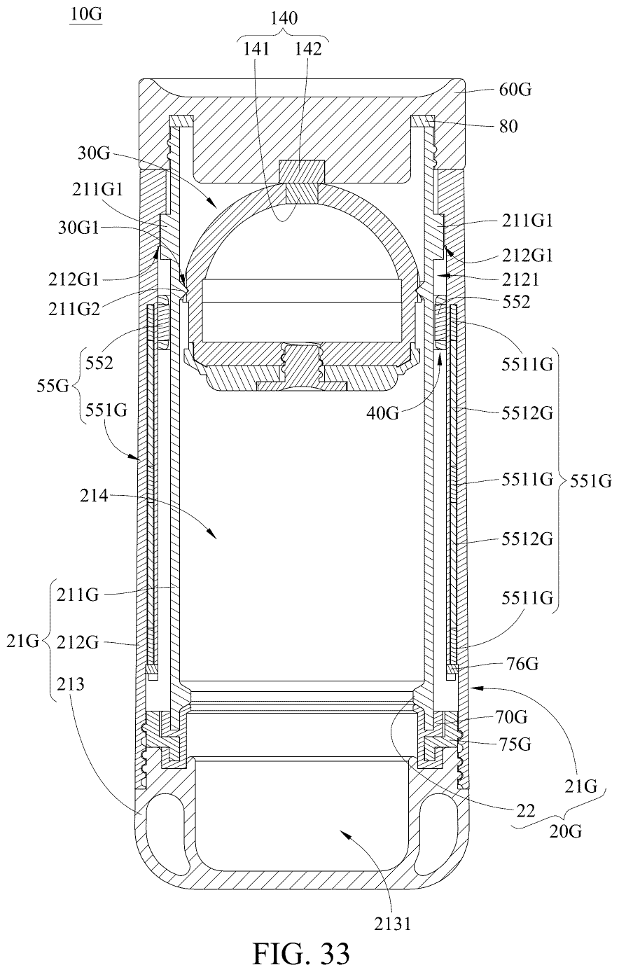

Please refer to FIG. 33, which is a cross-sectional view of a tumbler in accordance with an eighth embodiment of the present disclosure. The tumbler 10G of the present embodiment is similar to the tumbler 10F of the seventh embodiment. Accordingly, the following description will describe the differences between the present embodiment and the first embodiment, and repeated details will be omitted. In the tumbler 10G this embodiment, a first sealing pad 70G is formed integrally, and is not divided into two portions. A first positioning component 75G is disposed on one side of the first sealing pad 70G. When an outer bottle base 212G is assembled on an inner bottle part 211G, the inner bottle part 211G can be fixed to the outer bottle base 212G via the first positioning component 75G.

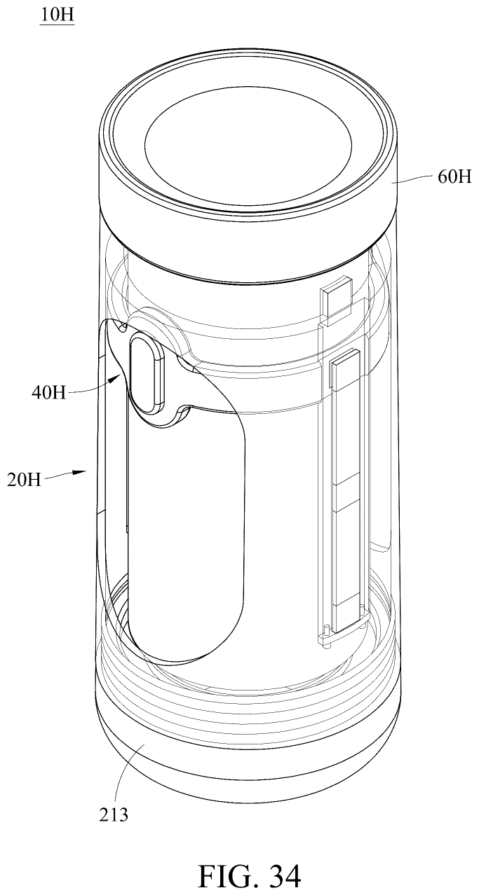

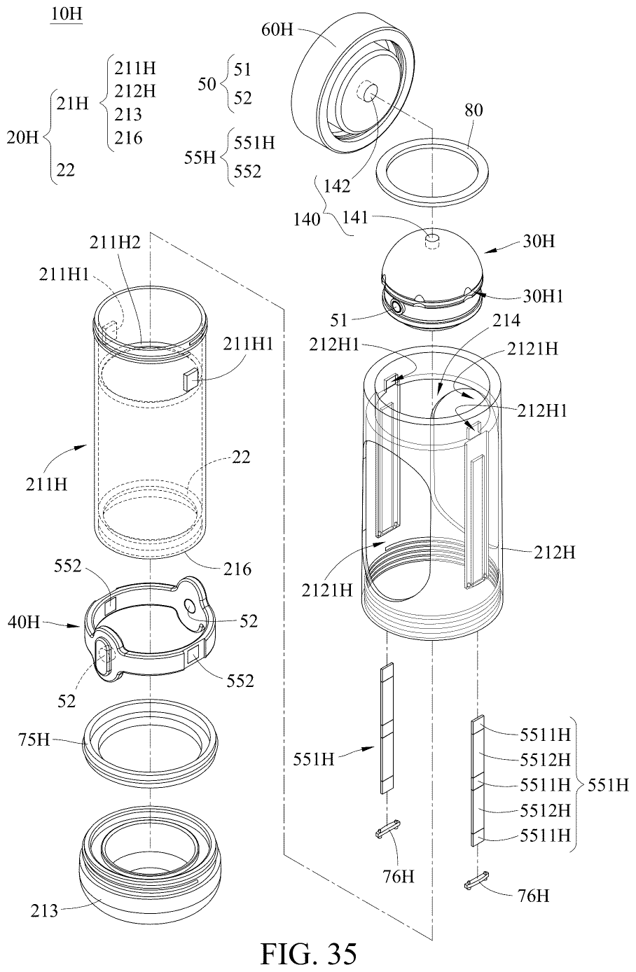

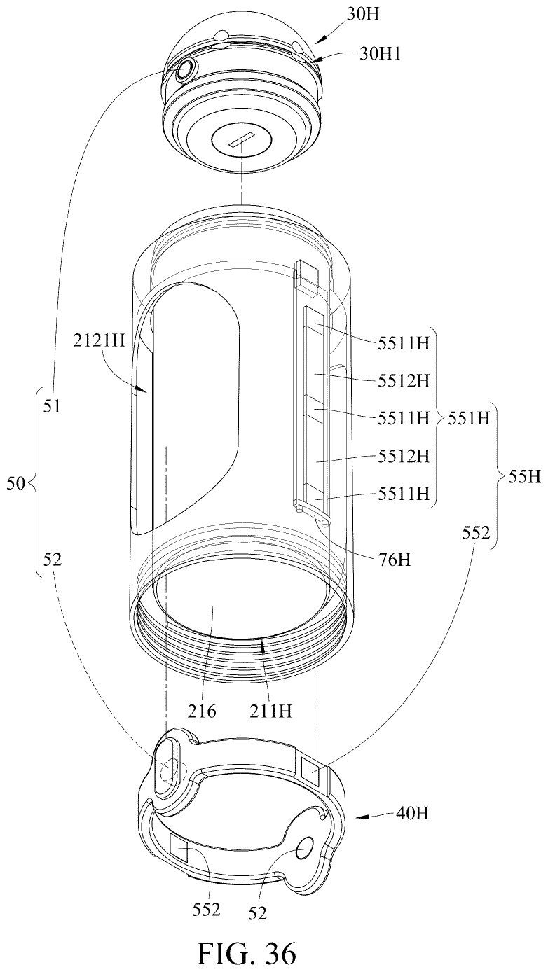

Please refer to FIG. 34 to FIG. 36, where FIG. 34 is a perspective view of a tumbler in accordance with a ninth embodiment of the present disclosure, FIG. 35 is an exploded view of the tumbler in FIG. 34, and FIG. 36 is a partially exploded view of the tumbler in FIG. 34. The tumbler 10H of the present embodiment is similar to the tumbler 10D of the fifth embodiment. Accordingly, the following description will describe the differences between the present embodiment and the first embodiment, and repeated details will be omitted.

In the tumbler 10H this embodiment, a bottle portion 21H includes a bottle base 216. The bottle base 216 is connected to an inner bottle part 211H, and the bottle base 216 and the inner bottle part 211H of the bottle portion 21H together form a first accommodating space 214H. The lower cover 213 is assembled on the bottle portion 21H, and does not form the second accommodating space. The brewing substance (not shown) is required to be placed into the tumbler 10H through a mouth thereof. Since the bottle base 216 is connected to the inner bottle part 211H and covers the first accommodating space 214H, the tumbler 10H does not include the first sealing pad.

In this embodiment, the inner bottle part 211H is made of, for example, glass. In addition, sizes of openings 2121H of an outer bottle base 212H are, for example, larger than sizes of the openings of the outer bottle base of the first embodiment. Accordingly, the brewed beverage (not shown) located in the inner bottle part 211H is visible from outside via the inner bottle part 211H made of glass and the openings 2121H having large sizes. Therefore, the user can observe a brewing condition of the brewed beverage easily and directly.

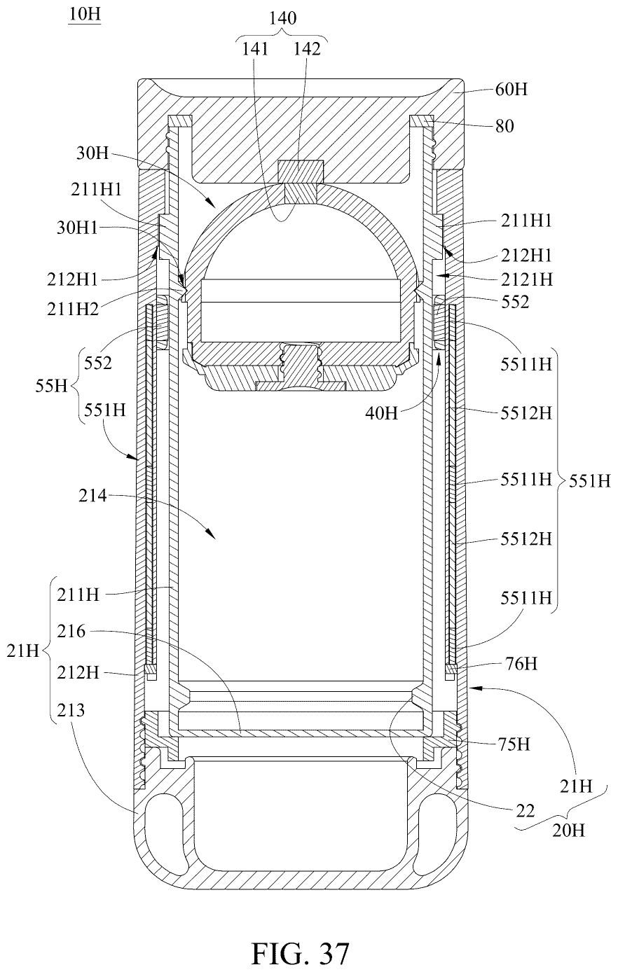

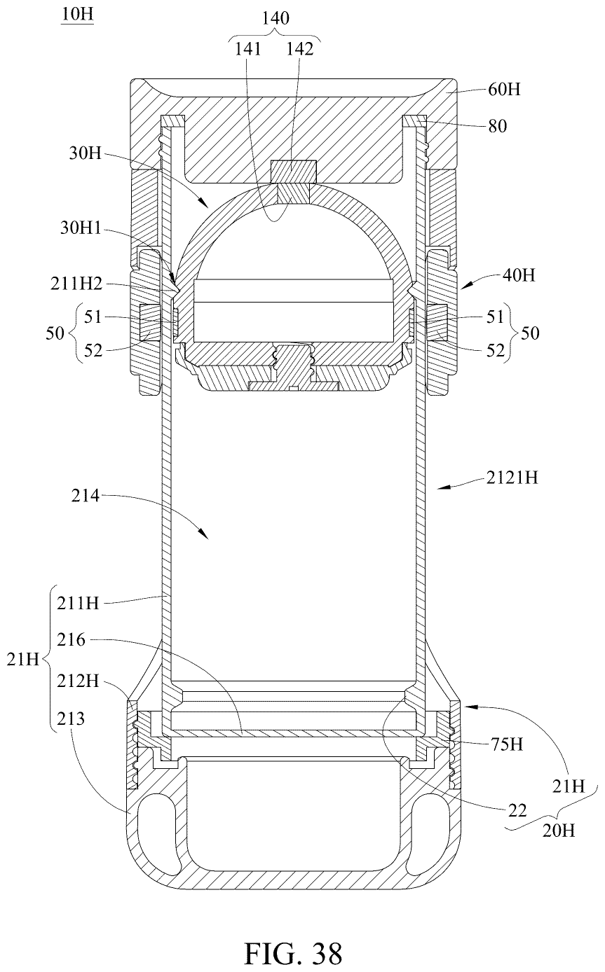

Please refer to FIG. 34 to FIG. 38, where FIG. 37 is a cross-sectional view of the tumbler in FIG. 34, and FIG. 38 is a cross-sectional view of the tumbler 10H in FIG. 34 from another viewing angle.

In this embodiment, there are, for example, three attracting portions 5511H of each of third magnetic components 551H and two repelling portions 5512H of each of the third magnetic components 551H. The three attracting portions 5511H and the two repelling portions 5512H are arranged alternately. One of the three attracting portions 5511H corresponds to one of the openings 2121H, and the other attracting portions 5511H correspond to the brewing position and the drinking position, respectively.

The inner bottle part 211H is made of glass, such that the tumbler body 20H does not form a double-layered thermal insulation structure. Thus, the thermally insulating performance of the tumbler body 20H is inferior to the thermally insulating performance of the tumbler body of the first embodiment. Accordingly, the heat generated by the hot brewed beverage is transferred to the outer bottle base 212H, such that the outer bottle base 212H can scald the user. In this regard, when the user moves the lifting component 30H to the attracting portions 5511H corresponding to the openings 2121H, the user can hold the manipulated component 40H to prevent the his/her hand from touching the outer bottle base 212H directly. Therefore, the outer bottle base 212H does not scald the his/her hand, such that the tumbler 10H can be facilitated to be held.

In this embodiment, there are three attracting portions 5511H of each of the third magnetic components 551H and two repelling portions 5512H of each of the third magnetic components 551H, and the three attracting portions 5511H and the two repelling portions 5512H are arranged alternately, but the present disclosure is not limited thereto. In other embodiment, there may be one attracting portion and one repelling portion of each of the third magnetic components, and the attracting portion corresponds to the brewing position or the drinking position. That is, the manipulated component and the lifting component may be positioned at the brewing position or the drinking position merely via the magnetic attraction generated between the attracting portion and the repelling portion.

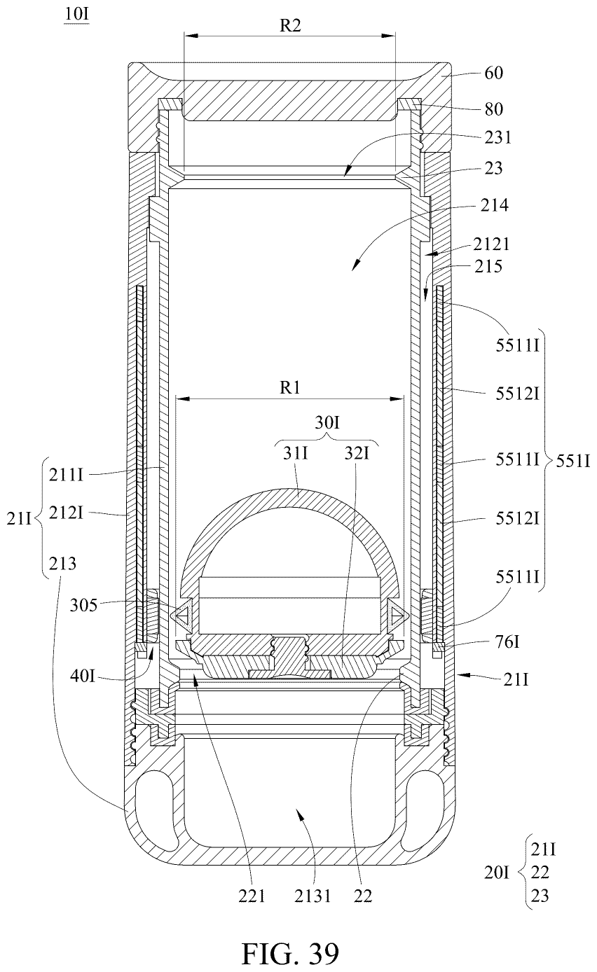

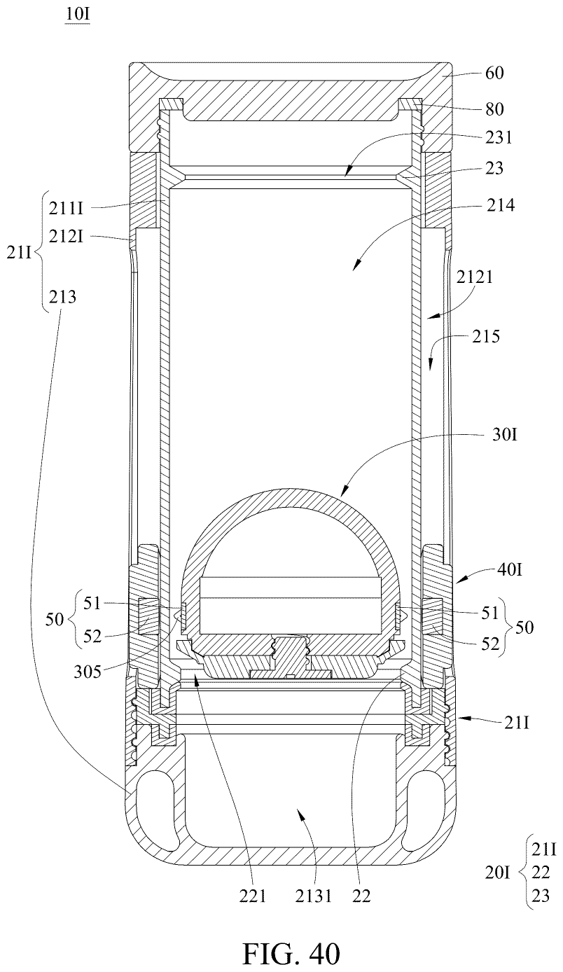

Please refer to FIG. 39 and FIG. 40, where FIG. 39 is a cross-sectional view of a tumbler in accordance with a tenth embodiment of the present disclosure, and FIG. 40 is a cross-sectional view of the tumbler in FIG. 39 from another viewing angle. The tumbler 10I of the present embodiment is similar to the tumbler 10B of the third embodiment. Accordingly, the following description will describe the differences between the present embodiment and the first embodiment, and repeated details will be omitted.

In this embodiment, the tumbler 10I includes an elastic component 305. The elastic component 305 is disposed on a lifting component 30I. In addition, a tumbler body 20I includes an upper blocking portion 23. The upper blocking portion 23 protrudes from a position located close to a mouth of a bottle portion 21I, and is located in the first accommodating space 214. That is, the lower blocking portion 22 and the upper blocking portion 23 are located on two opposite sides of the bottle portion 211, respectively. The lower blocking portion 22 forms a first through hole 221. The upper blocking portion 23 forms a second through hole 231. The first through hole 221 and the second through hole 231 are in fluid communication with the first accommodating space 214. A maximum diameter R1 of the lifting component 30I is greater than a diameter R2 of the second through hole 231. That is, the lifting component 30I is blocked by the upper blocking portion 23, such that the lifting component 30I cannot assembled into the first accommodating space 214 from the mouth of the bottle portion 21I via the second through hole 231.

Generally, if the hot water has already been filled in the tumbler 10I, the lifting component 30I may be assembled into the first accommodating space 214 from the mouth of the bottle portion 21I too quickly due to the excessively strong magnetic force generated between the first magnetic components 51 and the second magnetic components 52 during assembly, such that the hot water may be splashed out from the tumbler 10I, thereby scalding the user. In this embodiment, the lifting component 30I is blocked by the upper blocking portion 23 protruding from a position located close to the mouth of the bottle portion 211, such that the lifting component 30I cannot be assembled into the first accommodating space 214 from the mouth of the bottle portion 21I through the second through hole 231. The user can only open the lower cover 213 firstly, and then assembles the lifting component 30I into the first accommodating space 214 through the first through hole 221 via the lower blocking portion 22 pressing the elastic component 305 and the elastic separating portion 32I. Since the user is required to open the lower cover 213 firstly, the hot water cannot be filled in the tumbler 10I in advance. As a result, the hot water cannot be splashed out of the tumbler 10I, such that a risk of scalding the user can be prevented.

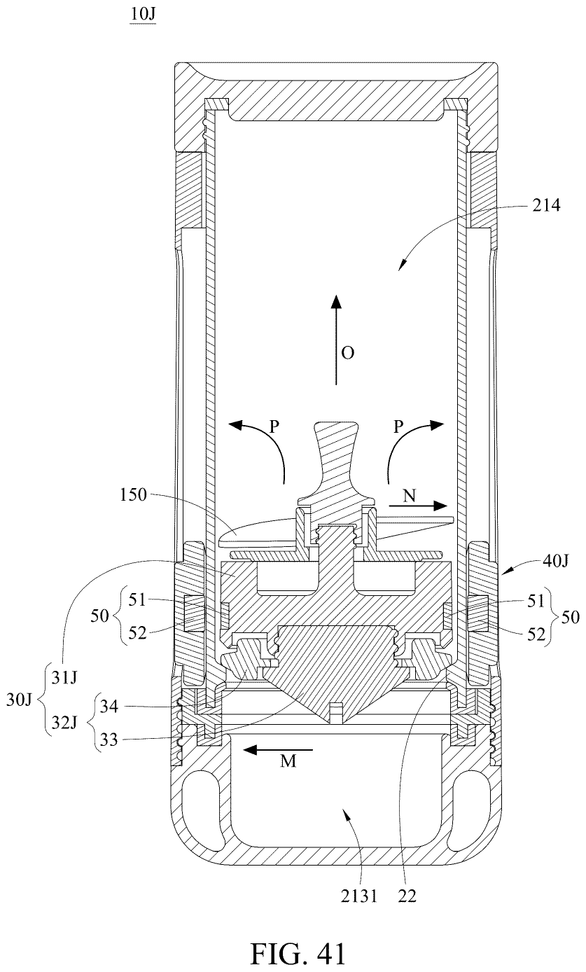

Please refer to FIG. 41, which is a cross-sectional view of a tumbler in accordance with an eleventh embodiment of the present disclosure. The tumbler 10J of the present embodiment is similar to the tumbler 10D of the fifth embodiment. Accordingly, the following description will describe the differences between the present embodiment and the first embodiment, and repeated details will be omitted.

In the tumbler 10J this embodiment, a separating portion 32J of a lifting component 30J includes a compressing member 33 and a separating member 34. The separating member 34 is assembled on the compressing member 33. The compressing member 33 is, for example, conical, and is assembled on a hollow portion 31J. Accordingly, when the lifting component 30J is located at the drinking position, the brewing substance (not shown) can be pressed by the compressing member 33, such that the brewing substance is entirely located in the second accommodating space 2131. Therefore, the brewing substance can be prevented from being unexpectedly located between the separating portion 32J and the lower blocking portion 22, thereby maintaining the blocking performance between the separating portion 32J and the lower blocking portion 22.

In addition, the separating member 34 can be movable relative to the compressing member 33 to be shifted. When the manipulated component 40J forces the lifting component 30J to be moved via the first magnetic assembly 50, the lifting component 30J may be shifted due to a deviation of the magnetic attraction. Therefore, the lifting component 30J may not be concentrically disposed in the tumbler 10J, thereby reducing the sealing performance between the separating portion 32J and the lower blocking portion 22. In this embodiment, when the lifting component 30J is shifted, for example, along a direction M, the separating member 34 can be pushed by the compressing member 33 to be shifted, for example, along a direction N since the separating member 34 is movable the compressing member 33. Accordingly, the separating member 34 can be returned to a concentric position in the tumbler 10J along the direction N.

In this embodiment, the tumbler 10J further includes a flow guide blade 150. The flow guide blade 150 is disposed on a side of the hollow portion 31J of the lifting component 30J away from the separating portion 32J. The flow guide blade 150 is made of, for example, an elastic material, but the present disclosure is not limited thereto. In other embodiment, the flow guide blade may be made of, for example, a rigid material. When the user pours the hot water into the tumbler 10J and moves the lifting component 30J from the drinking position to the brewing position along a direction O, the hot water flows rapidly with the lifting component 30J along the direction O. Accordingly, the hot water may be splashed out from the mouth of the tumbler 10J easily, thereby scalding the user. Therefore, the hot water can be guided to flow along a direction P via the flow guide blade 150 disposed on the hollow portion 31J when the lifting component 30J is moved from the drinking position to the brewing position along the direction O. That is, the flow guide blade 150 can guide the hot water to be redirected when the lifting component 30J is moved from the drinking position to the brewing position. Thus, the hot water does not flow directly toward the mouth of the tumbler 10J, thereby preventing the hot water from being splashed out of the tumbler 10J. As a result, the risk of scalding the user can be lowered.

In addition, the flow guide blade 150 can be movable relative to the lifting component 30J to be shifted. When the manipulated component 40J forces the lifting component 30J to be moved via the first magnetic assembly 50, the lifting component 30J may be shifted due to the deviation of the magnetic attraction. Therefore, the lifting component 30J may not be concentrically disposed in the tumbler 10J. At this time, the flow of the hot water in the tumbler 10J may be uneven. Accordingly, the hot water may be splashed out of the tumbler 10J easily, thereby scalding the user. In this embodiment, when the lifting component 30J is shifted, for example, along the direction M, the flow guide blade 150 can be pushed by the lifting component 30J to be shifted, for example, along the direction N since the flow guide blade 150 is movable the lifting component 30J. Accordingly, the flow guide blade 150 can be returned to a concentric position in the tumbler 10J along the direction N.

According to the tumbler as described in the above embodiments, the manipulated component can force the lifting component to be moved between the brewing position and the drinking position via the magnetic force. In detail, when the lifting component is located at the brewing position, the separating portion is detached from the lower blocking portion, and the first accommodating space and the second accommodating space respectively located on opposite two sides of the lifting component are in fluid communication with each other via the hollow portion. When the lifting component is located at the drinking position, the separating portion presses against the lower blocking portion to from a separating structure together with the lower blocking portion, and the fluid communication between the first accommodating space and the second accommodating space respectively located on opposite two sides of the lifting component blocked by the separating structure blocking the hollow portion. Therefore, the brewed beverage is separated from the brewing substance, thereby terminating the brewing process for the brewing substance. Thus, when the concentration of the brewed beverage in the tumbler does not meet his/her preference, the lifting component can be moved between the brewing position and the drinking position to regulate the concentration of the brewed beverage. Accordingly, the user can enjoy the brewed beverage with an optimal flavor.

In addition, in the conventional tumbler, the manipulated component forcing the lifting component to be moved is located close to a mouth of the bottle portion. Therefore, during the brewing process, the user cannot close the upper cover onto the tumbler body until the brewing process is completed. On the contrary, in the present disclosure, since the manipulated component 40 forcing the lifting component 30 to be moved is located on two opposite sides of the tumbler body 20, the manipulated component 40 does not obstruct the upper cover 60 from being closed onto the tumbler body 20. As a result, when the user is in a hurry to go out, the user can firstly close the upper cover 60 onto the tumbler body 20, and then moves the lifting component 30 to the brewing position via the manipulated component 40 while on the go. Accordingly, the user does not require to spend additional time waiting for the brewed beverage 300 to finish the brewing, thereby saving the brewing time and improving the convenience of beverage preparation.

In addition, the assembling post and the guide blocks of the rotating component can force the flow regulating component to be rotated, such that the connecting holes having different sizes can be in fluid communication with the spout selectively. Therefore, the user can adjust the flow regulating component according to the requirement thereof to select the connecting hole with suitable size.

In addition, the tumbler includes the third magnetic components and the fourth magnetic components, and the manipulated component and the lifting component are held at the brewing position or the drinking position via the magnetic attraction between the attracting portions of the second magnetic assembly and the fourth magnetic components. Therefore, the manipulated component and the lifting component can be located at the brewing position or the drinking position more firmly. In addition, the frictional force generated during the movement of the fourth magnetic components relative to the repelling portion can be reduced via the repelling force generated between the repelling portion of the second magnetic assembly and the fourth magnetic components. Therefore, the manipulated component and the lifting component can be moved more smoothly between the brewing position and the drinking position.

Moreover, the upper cover has the air hole, and the closure component is movably disposed at the air hole. Thus, the air located outside the tumbler can flow into the tumbler through the air hole. Therefore, the user can quickly move the lifting component to inject the air located outside the tumbler into the brewed beverage in the tumbler through the air hole. Accordingly, the milk foam or the froth can be generated in the brewed beverage for the user to enjoy.

1. A tumbler, comprising:
a tumbler body, comprising a bottle portion and a lower blocking portion, wherein the bottle portion has an accommodating space, the lower blocking portion protrudes from the bottle portion, and the lower blocking portion is located in the accommodating space;
a lifting component, located in the accommodating space, wherein the lifting component comprises a separating portion and at least one hollow portion, the at least one hollow portion is connected to the separating portion;
a manipulated component, located outside the accommodating space, wherein the manipulated component is movably disposed on the bottle portion, and the manipulated component is configured to be moved along an axial direction thereof; and
a first magnetic assembly, comprising at least one first magnetic component and at least one second magnetic component, wherein the at least one first magnetic component is disposed on the lifting component, the at least one second magnetic component is disposed on the manipulated component, the at least one second magnetic component attracts the at least one first magnetic component, and the manipulated component forces the lifting component to be moved between a brewing position and a drinking position relative to the bottle portion via a magnetic force;
wherein when the lifting component is located at the brewing position, the separating portion is detached from the lower blocking portion, and two spaces respectively located on opposite two sides of the lifting component are in fluid communication with each other via the at least one hollow portion; when the lifting component is located at the drinking position, the separating portion presses against the lower blocking portion to from a separating structure together with the lower blocking portion, and the fluid communication between two spaces respectively located on opposite two sides of the lifting component blocked by the separating structure blocking the at least one hollow portion.

2. The tumbler according to claim 1, wherein the bottle portion has at least one sliding recess, the at least one sliding recess is spaced apart from the accommodating space, and the manipulated component is slidably located in the at least one sliding recess.

3. The tumbler according to claim 2, wherein the bottle portion comprises an inner bottle part, an outer bottle base, a bottle base and a lower cover, the inner bottle part forms the accommodating space, the outer bottle base is sleeved over and assembled on the inner bottle part, the at least one sliding recess is formed between the outer bottle base and the inner bottle part, the outer bottle base has at least one opening, the at least one opening is connected to the at least one sliding recess, the bottle base is connected to the inner bottle part, the lower cover is assembled on the bottle portion, and the lower cover covers the at least one sliding recess.

4. The tumbler according to claim 2, wherein the bottle portion comprises an inner bottle part, an outer bottle base and a lower cover, the inner bottle part forms the accommodating space, the outer bottle base is sleeved over and assembled on the inner bottle part, the at least one sliding recess is formed between the outer bottle base and the inner bottle part, the outer bottle base has at least one opening, the at least one opening is connected to the at least one sliding recess, the lower cover is assembled on the bottle portion, and the lower cover covers the at least one sliding recess and the accommodating space.

5. The tumbler according to claim 4, further comprising a second magnetic assembly, wherein the second magnetic assembly comprises at least one third magnetic component and at least one fourth magnetic component, the at least one third magnetic component is disposed on the bottle portion, the at least one third magnetic component comprises at least one attracting portion, the at least one attracting portion corresponds to the brewing position or the drinking position, the at least one fourth magnetic component is disposed on the manipulated component, the at least one fourth magnetic component is configured to attract the at least one attracting portion to position the manipulated component and the lifting component at the brewing position or the drinking position.

6. The tumbler according to claim 5, wherein the at least one attracting portion of the at least one third magnetic component comprises two attracting portions, the at least one third magnetic component further comprises at least one repelling portion, the two attracting portions are disposed on two opposite ends of the at least one repelling portion, respectively, the two attracting portions correspond to the brewing position and the drinking position, respectively, a magnetic pole of the two attracting portions is different from a magnetic pole of the at least one fourth magnetic component, the two attracting portions attract the at least one fourth magnetic component, thereby holding the manipulated component and the lifting component at the brewing position or the drinking position, a magnetic pole of the at least one repelling portion is identical to the magnetic pole of the at least one fourth magnetic component, the at least one repelling portion repels the at least one fourth magnetic component, and the manipulated component and the lifting component is configured to be moved smoothly between the brewing position and the drinking position via a repelling force between the at least one repelling portion and the at least one fourth magnetic component.

7. The tumbler according to claim 6, wherein the manipulated component comprises an annual portion and at least one manipulated portion, the at least one manipulated portion is disposed on a side of the annual portion, and the at least one manipulated portion is located at the at least one opening of the outer bottle base.

8. The tumbler according to claim 7, wherein the at least one third magnetic component is disposed on the inner bottle part, the at least one fourth magnetic component is disposed on the at least one manipulated portion of the manipulated component, and the inner bottle part is located between the at least one third magnetic component and the at least one fourth magnetic component.

9. The tumbler according to claim 7, wherein the at least one third magnetic component is disposed on the outer bottle base, the annual portion of the manipulated component has at least one slot, and the at least one fourth magnetic component is disposed in the at least one slot.

10. The tumbler according to claim 4, further comprising a first sealing pad, wherein the first sealing pad is clamped between the lower cover and the bottle portion.

11. The tumbler according to claim 10, further comprising a first positioning component, wherein the first positioning component is disposed on a side of the first sealing pad, and the first positioning component is configured to hold the inner bottle part in position within the outer bottle base.

12. The tumbler according to claim 11, wherein the first sealing pad comprises two sealing portions, the two sealing portions are spaced apart from each other, and at least a part of the first positioning component is clamped between the two sealing portions.

13. The tumbler according to claim 4, further comprising an upper cover, wherein the upper cover is detachably assembled on the bottle portion, and the upper cover and the lower cover is located on two opposite ends of the accommodating space, respectively.

14. The tumbler according to claim 13, further comprising a closure component, wherein the upper cover has an air hole, and the closure component is movably disposed at the air hole to close the air hole or open the air hole.

15. The tumbler according to claim 13, further comprising a second sealing pad, wherein the second sealing pad is clamped between the upper cover and the bottle portion.

16. The tumbler according to claim 13, wherein the upper cover comprises an assembling base, a pivot, a cover body and an elastic component, the assembling base is detachably assembled on the bottle portion, the assembling base has a spout, the cover body is pivotally disposed on the assembling base via the pivot to close the spout, the pivot has a helical protrusion, the elastic component is sleeved over the pivot, and two opposite ends of the elastic component press against the helical protrusion and the cover body, respectively.

17. The tumbler according to claim 16, further comprising a flow regulating component, wherein the flow regulating component has at least two connecting holes, sizes of the at least two connecting holes are different, the flow regulating component is rotatably disposed on the assembling base, and one of the at least two connecting holes is selectively aligned with the spout.

18. The tumbler according to claim 17, further comprising a push-push telescopic structure, wherein the push-push telescopic structure comprises an assembling post, a sleeve, a rotating component and a pressing component, the assembling post is fixed to the assembling base, the sleeve and the rotating component are fixed to the flow regulating component, the sleeve surrounds the rotating component, the pressing component is slidably located in the sleeve, each of the assembling post and the rotating component has at least one guide block, the at least two guide blocks match each other, the pressing component is pressably disposed on the rotating component, and the pressing component forces the flow regulating component to be rotated via the at least two guide blocks matching each other and the rotating component.

19. The tumbler according to claim 18, further comprising a restoring component, wherein two opposite ends of the restoring component presses against the assembling base and the flow regulating component, respectively.

20. The tumbler according to claim 13, further comprising a third magnetic assembly, wherein the third magnetic assembly comprises a fifth magnetic component and a sixth magnetic component, the fifth magnetic component is disposed on the lifting component, the sixth magnetic component is disposed on the upper cover, and the fifth magnetic component is configured to attract the sixth magnetic component to position the lifting component at the drinking position.

21. The tumbler according to claim 4, wherein when the lifting component is located at the drinking position, a central portion of the at least one first magnetic is component farther away from the lower cover than a central portion of the at least one second magnetic component.

22. The tumbler according to claim 4, wherein the inner bottle part comprises a first positioning structure, the outer bottle base comprises a second positioning structure, the first positioning structure and the second positioning structure are a protrusion and a recess matching each other, and the inner bottle part is held in position within the outer bottle base via the first positioning structure and the second positioning structure.

23. The tumbler according to claim 4, wherein the inner bottle part comprises a third positioning structure, the lifting component comprises a fourth positioning structure, the third positioning structure and the fourth positioning structure are a protrusion and a recess matching each other, and the lifting component is held at the drinking position via the third positioning structure and the fourth positioning structure.

24. The tumbler according to claim 5, further comprising a second positioning component, wherein the second positioning component is disposed on a side of the at least one third magnetic component located close to the lower cover, and the second positioning component is configured to hold the second magnetic assembly in position.

25. The tumbler according to claim 1, further comprising a filter component, wherein the filter component is disposed through the at least one hollow portion of the lifting component.

26. The tumbler according to claim 1, wherein the tumbler body further comprises an upper blocking portion, wherein the upper blocking portion protrudes from the bottle portion, the upper blocking portion is located in the accommodating space, the lower blocking portion and the upper blocking portion are located on two opposite sides of the bottle portion, respectively, the lower blocking portion forms a first through hole, the upper blocking portion forms a second through hole, the first through hole and the second through hole are in fluid communication with the accommodating space, and a maximum diameter of the lifting component is greater than a diameter of the second through hole.

27. The tumbler according to claim 26, further comprising an elastic component, wherein the elastic component is disposed on the lifting component.

28. The tumbler according to claim 1, wherein the separating portion of the lifting component comprises a compressing member and a separating member, the separating member is assembled on the compressing member, and the compressing member is assembled on the at least one hollow portion.

29. The tumbler according to claim 28, wherein the separating member is movable relative to the compressing member to be shifted.

30. The tumbler according to claim 28, wherein the compressing member is conical.

31. The tumbler according to claim 1, further comprising a flow guide blade, wherein the flow guide blade is disposed a side of the at least one hollow portion of the lifting component away from the separating portion.

32. The tumbler according to claim 31, wherein the flow guide blade is movable relative to the lifting component to be shifted.
